(19) United States
(12) Patent Application Publication
(10) Pub. No.: US 2025/0245390 A1
(43) Pub. Date: Jul. 31, 2025

(54) Method and system for determining evaluation indexes based on on-line evaluation layered architecture for concrete dam operation performance

(71) Applicants: HUANENG LANCANG RIVER HYDROPOWER INC., Kunming (CN); HOHAI UNIVERSITY, Nanjing City (CN)

(72) Inventors: Hao CHEN, Kunming (CN); Hua ZHOU, Kunming (CN); Tengfei BAO, Kunming (CN); Hua MAO, Kunming (CN); Fudong CHI, Kunming (CN); Mingxin WU, Kunming (CN); Zhiyong ZHAO, Kunming (CN); Houlei XU, Kunming (CN); Xiaodi QIU, Kunming (CN); Chengdong LIU, Kunming (CN); Hua LIU, Kunming (CN); Xu CHEN, Kunming (CN); Bohui PANG, Kunming (CN); Zhuojing YU, Kunming (CN); Bingbing NIE, Kunming (CN); Shan ZHOU, Kunming (CN); Jun GUO, Kunming (CN); Longhai XI, Kunming (CN); Guangyao WU, Kunming (CN); Peng ZHANG, Kunming (CN); Haibo LIU, Kunming (CN); Baogang SONG, Kunming (CN); Yinan LI, Kunming (CN)

(73) Assignees: HUANENG LANCANG RIVER HYDROPOWER INC., Kunming (CN); HOHAI UNIVERSITY, Nanjing City (CN)

(21) Appl. No.: 18/831,451

(22) Filed: Jan. 24, 2025

(30) Foreign Application Priority Data
Jan. 24, 2024 (CN) 202410101103.0

(51) Int. Cl. G06F 30/13

(52) U.S. Cl. CPC G06F 30/13

(57) ABSTRACT

The present application relates to an on-line evaluation layered model including a monitoring data layer, a diagnosis method layer, an evaluation indicator layer, a monitored item layer, a key part layer, and an overall project layer. The method further includes collecting same-type multi-measuring-point monitoring data and multi-type multi-measuring-point monitoring data of a concrete dam, determining various indicator analysis results of the concrete dam based on the same-type multi-measuring-point monitoring data, determining various indicator operation scoring results of the concrete dam based on the multi-type multi-measuring-point monitoring data. In some embodiments, the method includes performing, based on the various indicator analysis results and the various indicator operation scoring results, analysis of an impact effect of external special loads on the dam caused by one or more risk events, and giving operation decision support suggestions of the dam in combination with overall performance graded evaluation of the dam.

### CROSS REFERENCE TO RELATED APPLICATIONS

The present application claims priority to the Chinese patent application No. 202410101103.0 filed on Jan. 24, 2024 to the China Patent Office, and entitled “METHOD AND SYSTEM FOR DETERMINING EVALUATION INDEXES BASED ON ON-LINE EVALUATION LAYERED ARCHITECTURE FOR CONCRETE DAM OPERATION PERFORMANCE”, the entire content of which is incorporated herein by reference.

### TECHNICAL FIELD

The present application relates to the technical field of structural safety monitoring for concrete dams, in particular to a method and system for determining evaluation indicators based on an on-line evaluation layered architecture for evaluating concrete dam operation performance.

### BACKGROUND

With the enrichment of dam monitoring technological means and the increase of the frequency of automated monitoring, monitoring data has not only significantly increased in quantity, but also continued to grow in dimension. Current dam safety assessment is mainly regular post-assessment, that is, after a period of operation of a dam (week, month, quarter, year, etc.), working condition monitoring data and on-site inspection materials of the dam during the period are compiled, statistical models or other models are established at key monitoring points of monitored items such as deformation, seepage, stress-strain and temperature of the dam, the change trend of data at typical monitoring points in key parts is analyzed, and then combined with experience and judgment of on-site operation and maintenance personnel and hydraulic technology experts, the operation safety of the dam is analyzed and assessed.

The operation period of the concrete dam is comprehensively influenced by multiple factors such as loads, structural types, terrain and geological conditions, and physical and mechanical properties of materials. It is difficult to make timely and comprehensive analysis of the overall operation performance of the concrete dam by relying solely on traditional monitoring data analysis methods. The demand for how to deeply explore the correlation between monitoring data and comprehensively analyze multi-dimensional data to jointly reflect potential structural safety hazards in engineering is becoming increasingly urgent.

### SUMMARY OF THE INVENTION

The present application aims to solve one of the technical problems in the related art at least to a certain extent.

For this purpose, a first objective of the present application is to propose a method for determining evaluation indicators based on an on-line evaluation layered architecture for evaluating concrete dam operation performance. An on-line evaluation layered model for evaluating concrete dam operation performance is acquired, wherein the on-line evaluation layered model includes a monitoring data layer, a diagnosis method layer, an evaluation indicator layer, a monitored item layer, a key part layer, and an overall project layer. Performing overall evaluation analysis on a concrete dam based on the on-line evaluation layered model includes the following steps: collecting same-type multi-measuring-point monitoring data and multi-type multi-measuring-point monitoring data of the concrete dam, wherein the same-type multi-measuring-point monitoring data include deformation monitoring data, seepage monitoring data, stress-strain monitoring data and temperature monitoring data; determining various indicator analysis results of the concrete dam based on the same-type multi-measuring-point monitoring data, wherein the various indicator analysis results include a deformation analysis result, a seepage analysis result, a stress-strain analysis result and a temperature analysis result; determining various indicator operation scoring results of the concrete dam based on the multi-type multi-measuring-point monitoring data, wherein the various indicator operation scoring results include a deformation scoring result, a seepage scoring result and a stress-strain scoring result; and performing overall evaluation analysis on the concrete dam based on the various indicator analysis results and the various indicator operation scoring results.

A second objective of the present application is to propose an on-line evaluation apparatus for concrete dam operation performance.

A third objective of the present application is to propose a system for determining evaluation indicators based on an on-line evaluation layered architecture for evaluating concrete dam operation performance.

A fourth objective of the present application is to propose a non-transitory computer-readable storage medium.

A fifth objective of the present application is to propose a computer program product.

For implementing the above objectives, an embodiment of a first aspect of the present application proposes a method for determining evaluation indicators based on an on-line evaluation layered architecture for evaluating concrete dam operation performance, including: acquiring an on-line evaluation layered model for evaluating concrete dam operation performance, wherein the on-line evaluation layered model includes a monitoring data layer, a diagnosis method layer, an evaluation indicator layer, a monitored item layer, a key part layer, and an overall project layer. Performing overall evaluation analysis on a concrete dam based on the on-line evaluation layered model includes the following steps: collecting same-type multi-measuring-point monitoring data and multi-type multi-measuring-point monitoring data of the concrete dam, wherein the same-type multi-measuring-point monitoring data include deformation monitoring data, seepage monitoring data, stress-strain monitoring data and temperature monitoring data; determining various indicator analysis results of the concrete dam based on the same-type multi-measuring-point monitoring data, wherein the various indicator analysis results include a deformation analysis result, a seepage analysis result, a stress-strain analysis result and a temperature analysis result; determining various indicator operation scoring results of the concrete dam based on the multi-type multi-measuring-point monitoring data, wherein the various indicator operation scoring results include a deformation scoring result, a seepage scoring result and a stress-strain scoring result; and performing overall evaluation analysis on the concrete dam based on the various indicator analysis results and the various indicator operation scoring results.

According to an embodiment of the present application, the overall project layer is a target of on-line evaluation of the concrete dam operation performance, and is used to comprehensively assess overall concrete dam operation performance; the key part layer is a focused object of on-line evaluation of the concrete dam operation performance, and key parts may be determined according to computational analysis in a concrete dam design phase or clustering analysis for long-term operation monitoring data, wherein the key part layer is used to analyze assessment results of special items of deformation, seepage, stress-strain and temperature monitoring effect values derived by the monitored item layer, and the key parts are mainly distributed in an upper dam body, a middle dam body, a riverbed dam segment heel, a riverbed dam segment toe and a dam foundation of the concrete dam as well as distribution part regions of defects of long-term concern in project operation; the monitored item layer is an association medium of on-line evaluation of the concrete dam operation performance, and according to currently-effective standards related to concrete dam design and safety monitoring, the special items of deformation, seepage, stress-strain and temperature monitoring effect values are comprehensively analyzed; the evaluation indicator layer is a process center of on-line evaluation of the concrete dam operation performance, and four types of evaluation indicators of deformation, seepage, stress-strain and temperature are respectively set corresponding to the deformation, seepage, stress-strain and temperature monitoring effect values of concrete dam operation safety in the monitored item layer, wherein under the various types of evaluation indicators, two indicator determining methods are further included: one is determining same-type multi-measuring-point combined calculation evaluation indicators for structural characteristics, and the other is determining data-driven multi-type multi-measuring-point zoned comprehensive evaluation indicators; the diagnosis method layer is an analysis core of on-line evaluation of the concrete dam operation performance, and on the basis of periodic effects of reservoir water and temperature loads in an operation period of the concrete dam and structural and material changes inside the concrete dam, same-type multi-point or multi-type multi-point monitoring effect value analysis is performed according to the same-type multi-measuring-point combined calculation evaluation indicators and the multi-type multi-measuring-point zoned comprehensive evaluation indicators proposed by the evaluation indicator layer; and the monitoring data layer is an information base of on-line evaluation of the concrete dam operation performance, and includes engineering safety monitoring data, walkaround inspection defect data and geophysical prospecting detection result data.

According to an embodiment of the present application, the step of determining the deformation analysis result in the various indicator analysis results of the concrete dam based on the same-type multi-measuring-point monitoring data includes: determining deformation analysis parameters of the concrete dam based on the deformation monitoring data in the same-type multi-measuring-point monitoring data, wherein the deformation analysis parameters include dam foundation deformation vertical distribution, overall horizontal displacement of a dam body, a horizontal displacement coordination degree of the dam body, an overall deflection of a dam segment, overall settlement of the dam body, inter-layer micro deformation of the dam body, an overall opening degree of a foundation surface and an overall opening degree of a structural joint; and performing deformation analysis on the concrete dam based on the deformation analysis parameters to obtain the deformation analysis result.

According to an embodiment of the present application, the step of determining the seepage analysis result in the various indicator analysis results of the concrete dam based on the same-type multi-measuring-point monitoring data includes: determining seepage analysis parameters of the concrete dam based on the seepage monitoring data in the same-type multi-measuring-point monitoring data, wherein the seepage analysis parameters include an overall uplift pressure reduction coefficient of the dam foundation, anti-sliding stability of the dam foundation, a structural joint osmotic pressure gradient and a key area seepage change amplitude; and performing seepage analysis on the concrete dam based on the seepage analysis parameters to obtain the seepage analysis result.

According to an embodiment of the present application, the step of determining the stress-strain analysis result in the various indicator analysis results of the concrete dam based on the same-type multi-measuring-point monitoring data includes: determining stress-strain analysis parameters of the concrete dam based on the stress-strain monitoring data in the same-type multi-measuring-point monitoring data, wherein the stress-strain analysis parameters include dam foundation stress vertical distribution, an overall horizontal stress of the dam body, a vertical beam-direction overall stress and a special part strain measuring point change amplitude; and performing stress-strain analysis on the concrete dam based on the stress-strain analysis parameters to obtain the stress-strain analysis result.

According to an embodiment of the present application, the step of determining the temperature analysis result in the various indicator analysis results of the concrete dam based on the same-type multi-measuring-point monitoring data includes: determining temperature analysis parameters of the concrete dam based on the temperature monitoring data in the same-type multi-measuring-point monitoring data, wherein the temperature analysis parameters include dam foundation temperature distribution and a dam body temperature gradient; and performing temperature analysis on the concrete dam based on the temperature analysis parameters to obtain the temperature analysis result.

According to an embodiment of the present application, the step of determining the various indicator operation scoring results of the concrete dam based on the multi-type multi-measuring-point monitoring data includes: performing region division on the key parts in concrete dam operation, and acquiring time-sequence measured value data of different types of monitoring instruments in a certain region from the multi-type multi-measuring-point monitoring data; establishing map structures for the time-sequence measured value data in time dimension and variable dimension respectively to obtain a time feature map and a variable feature map; inputting the time feature map and the variable feature map into a time map attention network and a variable map attention network respectively to obtain a time attention matrix and a variable attention matrix; splicing and inputting the time-sequence measured value data, the time attention matrix and the variable attention matrix into a gating convolutional network to obtain target features; and calculating abnormal scores according to the target features, and comparing the abnormal scores with preset indicator thresholds to obtain the operation scoring results of the corresponding indicators of the concrete dam.

According to an embodiment of the present application, the step of calculating the abnormal scores according to the target features includes: inputting the target features into a predicting module and a reconstructing module to obtain a prediction value and a reconstruction probability; and calculating the abnormal scores according to the prediction value and the reconstruction probability.

According to an embodiment of the present application, the predicting module is a multilayer perceptron.

According to an embodiment of the present application, the reconstructing module includes an arbiter and an autoencoder.

For implementing the above objectives, an embodiment of a second aspect of the present application proposes an on-line evaluation apparatus for concrete dam operation performance, including: a data collecting module, configured to collect same-type multi-measuring-point monitoring data and multi-type multi-measuring-point monitoring data of a concrete dam, wherein the same-type multi-measuring-point monitoring data include deformation monitoring data, seepage monitoring data, stress-strain monitoring data and temperature monitoring data; a first determining module, configured to determine various indicator analysis results of the concrete dam based on the same-type multi-measuring-point monitoring data, wherein the various indicator analysis results include a deformation analysis result, a seepage analysis result, a stress-strain analysis result and a temperature analysis result; a second determining module, configured to determine various indicator operation scoring results of the concrete dam based on the multi-type multi-measuring-point monitoring data, wherein the various indicator operation scoring results include a deformation scoring result, a seepage scoring result and a stress-strain scoring result; and an evaluation analysis module, configured to perform overall evaluation analysis on the concrete dam based on the various indicator analysis results and the various indicator operation scoring results.

For implementing the above objectives, an embodiment of a third aspect of the present application proposes a system for determining evaluation indicators based on an on-line evaluation layered architecture for evaluating concrete dam operation performance, including: at least one processor; and a memory in communication connection with the at least one processor; wherein the memory has instructions stored therein that can be executed by the at least one processor, and the instructions, when executed by the at least one processor, causes the at least one processor to implement the method for determining evaluation indicators based on an on-line evaluation layered architecture for evaluating concrete dam operation performance described in the embodiment of the first aspect of the present application.

For implementing the above objectives, an embodiment of a fourth aspect of the present application proposes a non-transitory computer-readable storage medium storing computer instructions, wherein the computer instructions are used to implement the method for determining the evaluation indicators based on the on-line evaluation layered architecture for evaluating concrete dam operation performance described in the embodiment of the first aspect of the present application.

For implementing the above objectives, an embodiment of a fifth aspect of the present application proposes a computer program product including computer programs, and the computer programs, when executed by a processor, implement the method for determining the evaluation indicators based on the on-line evaluation layered architecture for evaluating concrete dam operation performance described in the embodiment of the first aspect of the present application.

The present application at least achieves the following beneficial effects: in the present application, the evaluation indicators reflecting the structural characteristics of the dam, such as same-type multi-measuring-point combined calculation for deformation, same-type multi-measuring-point combined calculation for seepage, same-type multi-measuring-point combined calculation for stress-strain and same-type multi-measuring-point combined calculation for temperatures, are determined, and at the same time, based on a data-driven idea, the multi-type multi-measuring-point zoned comprehensive evaluation indicators which can be applied to the monitored items such as deformation, seepage and stress-strain simultaneously are determined. In combination with the determination of the on-line evaluation indicators, various specific on-line diagnosis method sub-items are formed by further refining, laying a solid foundation for conducting quantitative derivation of the on-line evaluation layered model of concrete dam operation performance subsequently and realizing rapid and intelligent assessment of the concrete dam operation performance by integrating structural analysis and data driving.

### BRIEF DESCRIPTION OF THE DRAWINGS

The above and/or additional aspects and advantages of the present application will become apparent and easily understandable from the following description of embodiments in conjunction with the accompanying drawings, wherein:

FIG. 1 is a schematic diagram of an exemplary implementation of a method for determining evaluation indicators based on an on-line evaluation layered architecture for evaluating concrete dam operation performance shown in an embodiment of the present application.

FIG. 2 is a schematic diagram of an on-line evaluation architecture for evaluating concrete dam operation performance shown in the present application.

FIG. 3 is a schematic diagram of a multi-indicator map attention network model framework of key parts of a concrete dam shown in an embodiment of the present application.

FIG. 4 is an architectural diagram of F-GAT shown in an embodiment of the present application.

FIG. 5 is a framework diagram of an adversarial generative network shown in an embodiment of the present application.

FIG. 6 is a schematic diagram of an on-line evaluation apparatus for concrete dam operation performance shown in an embodiment of the present application.

FIG. 7 is a system for determining evaluation indicators based on an on-line evaluation layered architecture for evaluating concrete dam operation performance shown in an embodiment of the present application.

### DETAILED DESCRIPTION

Embodiments of the present application are described in detail below, and examples of the embodiments are shown in the accompanying drawings, wherein the same or similar reference numerals represent the same or similar elements or elements with the same or similar functions throughout. The embodiments described below with reference to the accompanying drawings are exemplary and are intended to explain the present application, instead of being construed as limiting the present application.

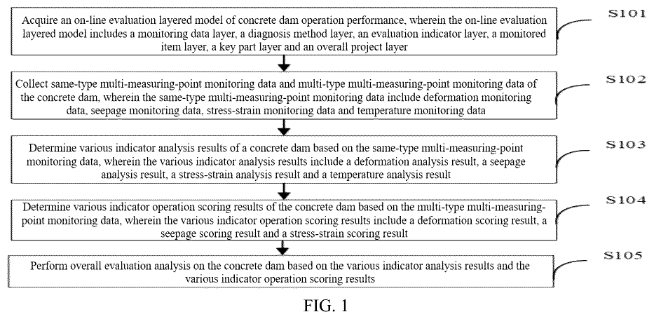

FIG. 1 is a schematic diagram of an exemplary implementation of a method for determining evaluation indicators based on an on-line evaluation layered architecture for evaluating concrete dam operation performance shown in the present application. As shown in FIG. 1, the method for determining the evaluation indicators based on the on-line evaluation layered architecture for evaluating concrete dam operation performance includes the following steps:

S101, an on-line evaluation layered model of the concrete dam operation performance is acquired, wherein the on-line evaluation layered model includes a monitoring data layer, a diagnosis method layer, an evaluation indicator layer, a monitored item layer, a key part layer and an overall project layer.

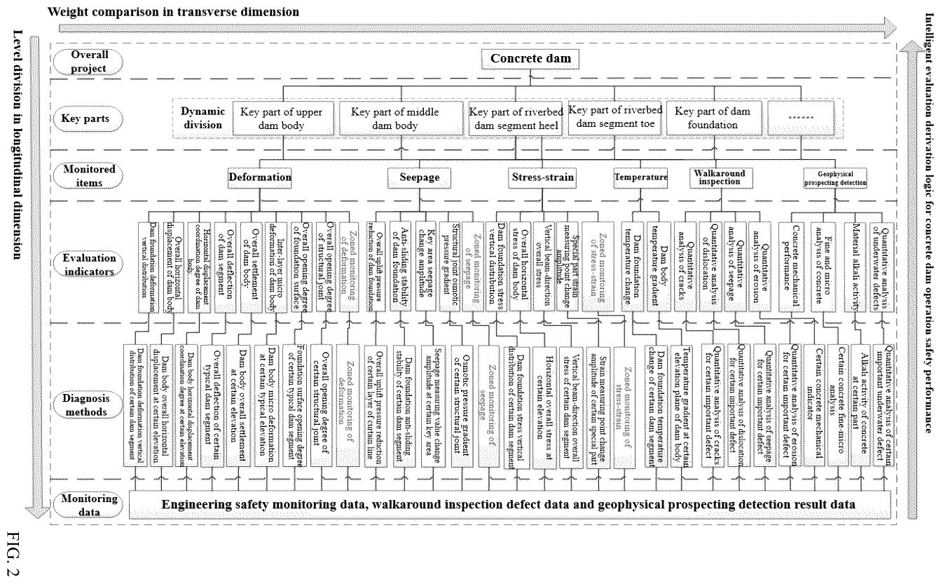

FIG. 2 is a schematic diagram of an on-line evaluation architecture for evaluating concrete dam operation performance shown in the present application. As shown in FIG. 2, the on-line evaluation layered architecture for evaluating concrete dam operation performance is divided into the following as shown in FIG. 2 from top to bottom:

### (1) Overall Project Layer

The overall project layer is a final target of on-line evaluation of the concrete dam operation performance, that is, overall concrete dam operation performance is comprehensively assessed.

### (2) Key Part Layer

The key part layer is a focused object of on-line evaluation of the concrete dam operation performance, and key parts may be determined according to computational analysis in a dam design phase or clustering analysis for long-term operation monitoring data. The key part layer is used to analyze assessment results of monitoring effect value special items such as deformation, seepage, stress-strain and temperature derived by the monitored item layer. The key parts are mainly distributed in an upper dam body, a middle dam body, a riverbed dam segment heel, a riverbed dam segment toe and a dam foundation as well as regions such as distribution parts of defects of long-term concern in project operation.

### (3) Monitored Item Layer

The monitored item layer is an association medium of on-line evaluation of the concrete dam operation performance, and according to currently-effective standards related to concrete dam design and safety monitoring, the monitoring effect value special items such as deformation, seepage, stress-strain, walkaround inspection, and geophysical prospecting detection are comprehensively analyzed, laying the foundation for performance assessment of the key parts of a concrete dam.

### (4) Evaluation Indicator Layer

The evaluation indicator layer is a process center of on-line evaluation of the concrete dam operation performance, and four types of evaluation indicators of deformation, seepage, stress-strain and temperature are respectively set corresponding to the monitored items such as deformation, seepage, stress-strain and temperature in concrete dam operation safety in the last layer. Under the various types of evaluation indicators, two indicator determining methods are further included: one is determining same-type multi-measuring-point combined calculation evaluation indicators for structural characteristics, and the other is determining data-driven multi-type multi-measuring-point zoned comprehensive evaluation indicators.

The same-type multi-measuring-point combined calculation evaluation indicators under deformation evaluation indicators are subdivided into dam foundation deformation vertical distribution, overall horizontal displacement of a dam body, a horizontal displacement coordination degree of the dam body, an overall deflection of a dam segment, overall settlement of the dam body, inter-layer micro deformation of the dam body, an overall opening degree of a foundation surface, an overall opening degree of a structural joint and the like. Besides, there are multi-type multi-measuring-point data comprehensive evaluation indicators for zoned monitoring of deformation.

The same-type multi-measuring-point combined calculation evaluation indicators under seepage evaluation indicators are subdivided into overall uplift pressure reduction of the dam foundation, anti-sliding stability of the dam foundation, a structural joint osmotic pressure gradient of the dam foundation, a key area seepage change amplitude, zoned monitoring of seepage and the like. Besides, there are multi-type multi-measuring-point data comprehensive evaluation indicators for zoned monitoring of seepage.

The same-type multi-measuring-point combined calculation evaluation indicators under stress-strain evaluation indicators are subdivided into dam foundation stress vertical distribution, an overall horizontal stress of the dam body, a vertical beam-direction overall stress, a special part strain measuring point change amplitude and the like. Besides, there are multi-type multi-measuring-point data comprehensive evaluation indicators for zoned monitoring of stress-strain.

Different-type evaluation indicator items include a dam foundation temperature gradient, a dam body temperature gradient and the like.

### (5) Diagnosis Method Layer

The diagnosis method layer is an analysis core of an intelligent assessment system for the concrete dam operation performance. With respect to periodic effects of loads such as reservoir water and temperature in an operation period of the concrete dam and structural and material changes inside the concrete dam, same-type multi-point or multi-type multi-point monitoring effect value analysis is performed according to the same-type multi-measuring-point combined calculation evaluation indicators and the multi-type multi-measuring-point zoned comprehensive evaluation indicators proposed by the evaluation indicator layer. For the evaluation indicators under the monitored item of deformation, diagnosis methods for the dam foundation deformation vertical distribution, the overall horizontal displacement of the dam body, the horizontal displacement coordination degree of the dam body, the overall deflection of the dam segment, the overall settlement of the dam body, the inter-layer micro deformation of the dam body, the overall opening degree of the foundation surface, the overall opening degree of the structural joint, zoned monitoring of deformation and the like are proposed. For the evaluation indicators under the monitored item of seepage, diagnosis methods for the overall uplift pressure reduction of the dam foundation, the anti-sliding stability of the dam foundation, the structural joint osmotic pressure gradient, the key area seepage change amplitude, zoned monitoring of seepage and the like are proposed. For the evaluation indicators under the monitored item of stress-strain, diagnosis methods for the dam foundation stress vertical distribution, the overall horizontal stress of the dam body, the vertical beam-direction overall stress, the special part strain measuring point change amplitude, zoned monitoring of the stress-strain and the like are proposed. For the evaluation indicators under the monitored item of the temperature, diagnosis methods for dam foundation temperature changes, the dam body temperature gradient and the like are specifically included. Values of calculation results in the diagnosis method layer are time-sequence data, and a correspondence relationship with an assessment set is established through a time sequence adaptive analysis method and the PauTa principle.

### (6) Monitoring Data Layer

The monitoring data layer is an information base of on-line evaluation of the concrete dam operation performance, and includes engineering safety monitoring data, walkaround inspection defect data and geophysical prospecting detection result data. The engineering safety monitoring data mainly include monitoring data of various types of measuring points for deformation, seepage, stress-strain and the like, such as direct and inverted plumb lines, a multi-point displacement meter, a hydrostatic level displacement meter, a one-way or two-way joint meter, an osmometer, a piezometer tube, a measuring weir, a one-way strain gauge, a multi-directional strain gauge group, an anchor stress gauge, and a steel rebar meter. The walkaround inspection defect data mainly include defect data with potential risks and a further development trend, such as cracks, joint misalignment, water seepage, and calcified precipitates discovered on a dam crest or upstream and downstream dam surfaces and galleries in the dam, as well as cavitation and erosion of flow holes in the dam body. The geophysical prospecting detection result data mainly include result data with potential risks and requiring continuous attention discovered through various technical checking or measuring means such as sound waves, images, lasers, and electromagnetic waves.

S102, same-type multi-measuring-point monitoring data and multi-type multi-measuring-point monitoring data of the concrete dam are collected, wherein the same-type multi-measuring-point monitoring data include deformation monitoring data, seepage monitoring data, stress-strain monitoring data and temperature monitoring data.

S103, various indicator analysis results of the concrete dam are determined based on the same-type multi-measuring-point monitoring data, wherein the various indicator analysis results include a deformation analysis result, a seepage analysis result, a stress-strain analysis result and a temperature analysis result.

S104, various indicator operation scoring results of the concrete dam are determined based on the multi-type multi-measuring-point monitoring data, wherein the various indicator operation scoring results include a deformation scoring result, a seepage scoring result and a stress-strain scoring result.

S105, overall evaluation analysis is performed on the concrete dam based on the various indicator analysis results and the various indicator operation scoring results.

In the present application, the evaluation indicators reflecting the structural characteristics of the dam, such as same-type multi-measuring-point combined calculation for deformation, same-type multi-measuring-point combined calculation for seepage, same-type multi-measuring-point combined calculation for stress-strain and same-type multi-measuring-point combined calculation for temperatures, are determined, and at the same time, based on a data-driven idea, the multi-type multi-measuring-point zoned comprehensive evaluation indicators which can be applied to the monitored items such as deformation, seepage and stress-strain simultaneously are determined. In combination with the determination of the on-line evaluation indicators, various specific on-line diagnosis method sub-items are formed by further refining, laying a solid foundation for conducting quantitative derivation of the on-line evaluation layered model of concrete dam operation performance subsequently and realizing rapid and intelligent assessment of the concrete dam operation performance by integrating structural analysis and data driving.

Optionally, in S103, when the deformation analysis result in the various indicator analysis results of the concrete dam is determined based on the same-type multi-measuring-point monitoring data, it is required to determine deformation analysis parameters of the concrete dam based on the deformation monitoring data in the same-type multi-measuring-point monitoring data, wherein the deformation analysis parameters include dam foundation deformation vertical distribution, overall horizontal displacement of a dam body, a horizontal displacement coordination degree of the dam body, an overall deflection of a dam segment, overall settlement of the dam body, inter-layer micro deformation of the dam body, an overall opening degree of a foundation surface and an overall opening degree of a structural joint; and it is also required to perform deformation analysis on the concrete dam based on the deformation analysis parameters to obtain the deformation analysis result.

In the following, analysis processes of the dam foundation deformation vertical distribution, the overall horizontal displacement of the dam body, the horizontal displacement coordination degree of the dam body, the overall deflection of the dam segment, the overall settlement of the dam body, the inter-layer micro deformation of the dam body, the overall opening degree of the foundation surface and the overall opening degree of the structural joint in deformation analysis are introduced in details respectively.

1. Analysis process of the dam foundation deformation vertical distribution is as follows.

According to existing researches, an impact range of loads, such as reservoir water, in an operation period of a concrete dam of 200 m to 300 m high on dam foundation deformation reaches 2-3 times a dam height in a vertical direction, which is beyond the limits of existing monitoring means. An analysis method for the dam foundation deformation vertical distribution is studied in combination with measured data so as to be used for analyzing a vertical impact range of dam foundation deformation of the concrete dam in the operation period.

When a monitoring instrument for the dam foundation deformation vertical distribution is selected, 3 inverted plumb lines distributed in a vertical direction of a dam segment with a maximum dam height but different in depth are selected, a length of the first inverted plumb line is usually 10% of the maximum dam height, a length of the second inverted plumb line is usually 30% of the maximum dam height, and a length of the third inverted plumb line is usually 50% of the maximum dam height.

According to a distribution law of deformations of the inverted plumb lines along different depths, a relevant calculation model function is established through Formula (1):

$$y = x / ( {k}_{1} + {k}_{2} x ) \qquad ( 1 )$$

in the formula, y is deformations corresponding to different depths, x is a plumb line depth, and k₁ and k₂ are undetermined coefficients.

A first inverted plumb line (x₁,y₁), a second inverted plumb line (x₂,y₂) and a third inverted plumb line (x₃,y₃) are set, k₁ and k₂ are calculated by using non-linear fitting, thereby establishing a calculation function of the plumb line depth x and the deformation y, and a theoretical maximum deformation yₘₐᵣ of a dam foundation is calculated by deriving the calculation function y.

Ratios of deformations yᵢ corresponding to different depths xᵢ of the dam foundation to the theoretical maximum deformation yₘₐₓ of the dam foundation are calculated through Formula (2):

$$α = {y}_{i} / {y}_{max} \qquad ( 2 )$$

in the formula, a corresponding depth xᵢ when α=98% is considered as a deformation depth of the dam foundation.

Historical comparative analysis of the dam foundation deformation vertical distribution is performed. Specifically: all previous dam foundation deformation vertical distribution calculated values xᵢ, xᵢ₊₁, . . . , xᵢ₊ₙ are fitted to obtain a current-period predicted value xᵢ′, which is compared with xᵢ calculated according to actual measurement in the latest period, their difference value is judged by adopting the PauTa principle, and based on this, whether the dam foundation deformation vertical distribution in the current period has abrupt changes or great change amplitudes compared to previous periods is quantitatively analyzed.

2. Analysis process of the overall horizontal displacement of the dam body is as follows.

When the concrete dam bears loads such as reservoir water, loads on upper and lower elevation parts of the dam body are mainly subjected to horizontal force, and a calculation method for representative elevation overall displacement of the dam body is studied so as to be used for analyzing an overall displacement situation of the concrete dam at different elevation planes.

When monitoring instruments for horizontal displacement of the dam are selected, direct plumb lines distributed at different representative dam segments such as a maximum-dam-height riverbed dam segment, an overflow dam segment and a dam segment affected by geological defects on bank slopes are selected; and at the same time, surface deformation monitoring points arranged on berms behind the dam at various typical elevations of the dam are selected to further verify monitoring results from the plumb lines and improve a monitoring coverage density.

An idea of calculating the overall horizontal displacement of the dam body: a correlation curve for a current-period monitoring amount of horizontal displacement at various typical elevations is established, and an overall horizontal displacement situation of a certain typical elevation is analyzed through a distribution probability of correlation coefficients of historical multi-period curves.

Specifically, a calculation method for the overall horizontal displacement of the dam body is as follows.

A spatial correlation model fₜ(xₘₙ,yₘₙ) is established according to spatial plane coordinate measured values A₁ₙ(x₁ₙ,y₁ₙ), A₂ₙ(x₂ₙ, y₂ₙ), . . . , Aₘₙ(xₘₙ, yₘₙ) of the direct plumb line at the same elevation of the representative dam segments or the surface deformation monitoring points on the berms behind the dam, so that arch ring horizontal displacement is embodied. xₘₙ and yₘₙ are spatial plane coordinate measured values of the direct plumb line or the surface deformation monitoring points on the berms behind the dam located on a layer n of a dam segment m respectively.

By adopting a Euclidean distance, a similarity between spatial correlation models fₜ₋ₖ and fₜ₍ₖ₋₁₎ of historical monitoring amounts in previous periods of the horizontal displacement at the typical elevation is calculated through Formula (3), and a similarity r₁^{t}, of the spatial correlation curves of the horizontal displacement at the typical elevation in adjacent two previous periods is obtained.

$${r}_{t}^{1} = \frac{1}{m} {\sum }_{k = 1}^{m} \sqrt{{( {x}_{kn}^{t} - {x}_{k n}^{t - 1} )}^{2} + {( {y}_{k n}^{t} - {y}_{k n}^{t - 1} )}^{2}} \qquad ( 3 )$$

When historical comparative analysis for the overall horizontal displacement of the dam body is performed, similarity coefficients r¹ₜ, r¹ₜ₋₁, . . . , r¹ₜ₋ₖ of historical spatial correlation curves of the horizontal displacement at the typical elevation are fitted to obtain a predicted value r₁^{t}′ in the current period, which is compared to r₁^{t}, calculated through actual measurement in the latest period, judgment is made by adopting the PauTa principle, and based on this, whether the overall deformation of the dam body in the current period has abrupt changes or great change amplitudes compared to previous periods is quantitatively analyzed.

3. Analysis process of the horizontal displacement coordination degree of the dam body is as follows.

Overall deformation performance of the concrete dam after bearing loads is an important basis for judging whether its working conditions are normal. However, due to the impact of geology, structures and temperatures, the dam body is prone to tangential asymmetric deformation in the operation period, and a calculation method for a horizontal displacement coordination degree of a representative elevation of the dam is studied so as to be used for analyzing asymmetric abrupt changes and trend development of displacement in dam segments of left and right banks of the dam.

When monitoring instruments for horizontal displacement of the dam body are selected, direct plumb lines distributed at different representative dam segments such as a maximum-dam-height riverbed dam segment, an overflow dam segment and a dam segment affected by geological defects on bank slopes are selected; and at the same time, surface deformation monitoring points arranged on berms behind the dam at various typical elevations of the dam are selected to further verify monitoring results from the plumb lines and improve a monitoring coverage density.

An idea of calculating the horizontal displacement coordination degree of the dam body: taking a center line of a certain dam body as an X axis, it is respectively defined that deformation monitoring data of the dam body in a direction perpendicular to a river are positive towards the left bank and negative towards the right bank, and deformation monitoring data of the dam body in a direction parallel to the river are positive towards the downstream and negative towards the upstream. Correlation curves of current-period displacement monitoring values of the dam segments of the left and right banks are established respectively, a spatial correlation curve of the displacement monitoring values of the dam segment of the right bank is transformed to a first quadrant of the Cartesian coordinate system so as to be compared with a spatial correlation curve of the displacement monitoring values of the dam segment of the left bank, and the displacement coordination degree of the dam segments of the left and right banks at a certain typical elevation is described through a distribution probability of correlation coefficients.

Specifically, a calculation method for the horizontal displacement coordination degree of the dam body is as follows.

A spatial correlation model f_{Z}(xₘₙ,yₘₙ) of a certain elevation on the dam segment of the left bank of the dam body and a spatial correlation model f_{Y}(xₘₙ,−yₘₙ) of the dam segment of the right bank are established according to spatial plane coordinate measured values A₁ₙ(x₁ₙ,y₁ₙ), A₂ₙ(x₂ₙ,y₂ₙ), . . . , Aₘₙ(xₘₙ, yₘₙ) of the direct plumb line of a representative dam segment at the same elevation or surface deformation monitoring points on a bridge behind the dam. xₘₙ and yₘₙ are spatial plane coordinate measured values of the direct plumb line or the surface deformation monitoring points on the bridge behind the dam located on a layer n of a dam segment m respectively.

A spatial correlation curve of displacement monitoring values of the dam segment of the right bank is subjected to coordinate transformation f_{Y}(xₘₙ,−yₘₙ)→-f_{Y}′(x′y′) into the first quadrant of the Cartesian coordinate system through Formula (4).

$${f}_{y}^{'} ( {x}^{'} , {y}^{'} ) = \{ \begin{matrix}{x}^{'} = {x}_{mn} \\ {y}^{'} = - {y}_{mn}\end{matrix} \qquad ( 4 )$$

By adopting the Pearson correlation coefficient, the correlation between the spatial correlation models f_{Z} and f_{Y} of current-period monitoring amounts of the displacement of the dam segments of the left and right banks is calculated, and the displacement coordination degree r²ₜ of the dam segments of the left and right banks in the current period is described by adopting the correlation.

Historical comparative analysis of the horizontal displacement coordination degree of the dam body: a time sequence prediction model is constructed by fitting historical coordination degrees r²ₜ, r²ₜ₋₁, . . . , r²ₜ₋ₖ of the displacement curves of the dam segments of the left and right banks. A current-period predicted value r²ₜ′ is compared to r²ₜ calculated according to actual measurement in the latest period, their difference value is judged by adopting the PauTa principle, and based on this, whether the displacement coordination degree of the dam segments of the left and right banks in the current period has abrupt changes or great change amplitudes compared to previous periods is quantitatively analyzed.

4. Analysis process of the overall deflection of dam segments is as follows.

When the concrete dam bears loads such as reservoir water, the upper portion and the lower portion of the dam body bear force together, playing a bearing role, and a calculation method for the overall deflection of the dam segments is studied to be used for analyzing vertical beam-direction deformation situations of various dam segments of the dam.

When monitoring instruments for the overall deflection of the dam segments are selected, representative dam segments are selected, and direct plumb lines are distributed on the different dam segments from the crest to the bottom. The direct plumb lines are adopted on key monitored dam segments, and monitoring data of surface observation points on berms behind the dam are adopted on non-key monitored dam segments.

A idea of calculating the overall deflection of the dam segments: taking typical dam segments as examples, beam-direction deflection deformation is calculated, deflection distribution curves of displacement variables of the dam segments in a direction parallel to a river vertically from top to bottom and corresponding elevations are established, and the change situation of the overall deflection of the dam segments is analyzed through a distribution probability of correlation coefficients of historical multi-period deflection distribution curves.

Specifically, a calculation method for the overall deflection of the dam segments is as follows.

A dam body spatial correlation model gₜ(xₘₙ,hₘₙ) is established according to displacement variables in the direction parallel to the river of the direct plumb line on a certain representative dam segment from top to bottom and elevations corresponding to monitoring point distribution A₁₁(x₁₁,h₁₁), A₁₂(x₁₂,h₁₂), . . . , A₁ₙ(x₁ₙ,h₁ₙ), and is used to embody deflection deformation of the certain representative dam segment. xₘₙ is a deformation monitoring amount in the direction parallel to the river of monitoring points on a layer n of a dam segment m, and hₘₙ is a distribution elevation of the monitoring points on the layer n of the dam segment m.

A Pearson correlation coefficient of spatial correlation models gₜ₋ₖ and gₜ₋₍ₖ₋₁₎ of historical monitoring amounts of beam-direction deformation in the previous periods is calculated through Formula (5), and a correlation coefficient r³ₜ of the spatial correlation curves of beam-direction deflection deformation in adjacent two previous periods is obtained.

$${r}_{t}^{3} = \frac{Cov ( {g}_{t - k} , {g}_{t - ( k - 1 )} )}{\sqrt{[ D ( {g}_{t - k} ) ]} \sqrt{[ D ( {g}_{t - ( k - 1 )} ) ]}} \qquad ( 5 )$$

In the formula, Cov(gₜ₋ₖ,gₜ₋₍ₖ₋₁₎ is a covariance of gₜ₋ₖ and gₜ₋₍ₖ₋₁₎, and D(gₜ₋ₖ) and D(gₜ₋₍ₖ₋₁₎) are variances of gₜ₋ₖ and gₜ₋₍ₖ₋₁₎ respectively.

Historical comparative analysis of the overall deflection of the dam segments: a time sequence prediction model is constructed by fitting correlation coefficients r³ₜ, r³ₜ₋₁, . . . , r³ₜ₋ₖ of historical deformation spatial correlation curves of the deflection of the dam body. A current-period predicted value r³ₜ′ is compared to r³ₜ calculated according to actual measurement in the latest period, their difference value is judged by adopting the PauTa principle, and based on this, whether the beam-direction deflection deformation in the current period has abrupt changes or great change amplitudes compared to previous periods is quantitatively analyzed.

5. Analysis process of the overall settlement of the dam body is as follows.

When the concrete dam bears loads such as the self-weight of the dam and reservoir water, settlement deformation in the vertical direction will occur, and a calculation method for the overall settlement deformation of the dam body is studied to be used for analyzing vertical settlement deformation situations of the dam body.

When monitoring instruments for settlement deformation of the dam body are selected, hydrostatic leveling points or artificial leveling points distributed on the dam crest, an in-dam inspection gallery at a typical elevation, and berms behind the dam are selected.

An idea of calculating the settlement deformation of the dam body: a correlation curve for a current-period monitoring amount of settlement deformation at various typical elevations is established, and an overall settlement situation of a certain typical elevation is analyzed through a distribution probability of correlation coefficients of historical multi-period curves.

Specifically, a calculation method for the settlement deformation of the dam body is as follows.

A settlement deformation spatial correlation model G/(xₘₙ,hₘₙ) of various dam segments of the dam body is established according to current-period monitoring amounts of vertical settlement deformation of the various dam segments at the same elevation and the corresponding elevation A₁₁(x₁₁,h₁₁), A₁₂(x₁₂,h₁₂), . . . , A₁ₙ(x₁ₙ,h₁ₙ). xₘₙ is a vertical settlement deformation monitoring amount of monitoring points on a layer n of a dam segment m, and hₘₙ is the elevation corresponding to the monitoring points on the layer n of the dam segment m.

A Pearson correlation coefficient of spatial correlation models Gₜ₋ₖ and Gₜ₋₍ₖ₋₁₎ of historical monitoring amounts of overall settlement deformation of the dam body in the previous periods is calculated through Formula (6), and a correlation coefficient r⁴ₜ of the spatial correlation curves of the overall settlement deformation of the dam body in adjacent two previous periods is obtained.

$${r}_{t}^{4} = \frac{Cov ( {g}_{t - k} , {g}_{t - ( k - 1 )} )}{\sqrt{[ D ( {g}_{t - k} ) ]} \sqrt{[ D ( {g}_{t - ( k - 1 )} ) ]}} \qquad ( 6 )$$

In the formula, Cov(Gₜ₋ₖ,Gₜ₋₍ₖ₋₁₎ is a covariance of Gₜ₋ₖ and Gₜ₋₍ₖ₋₁₎, and D(Gₜ₋ₖ) and D(Gₜ₋₍ₖ₋₁₎) are variances of Gₜ₋ₖ and Gₜ₋₍ₖ₋₁₎ respectively.

Historical comparative analysis of the overall settlement deformation of the dam body: a time sequence prediction model is constructed by fitting correlation coefficients r⁴ₜ, r⁴ₜ₋₁, . . . , r⁴ₜ₋ₖ of historical deformation spatial correlation curves of the overall settlement deformation of the dam body. A current-period predicted value r⁴ₜ′ is compared to r⁴ₜ calculated according to actual measurement in the latest period, their difference value is judged by adopting the PauTa principle, and based on this, whether the vertical settlement deformation in the current period has abrupt changes or great change amplitudes compared to previous periods is quantitatively analyzed.

6. Analysis process of the overall opening degree of the foundation surface is as follows.

An arch dam bears huge thrust from upstream reservoir water, anti-sliding stability of the dam is a major concern in the operation period, and a calculation method for the overall opening degree of the foundation surface of the arch dam is studied so as to be used for analyzing the anti-sliding stability of the dam foundation.

When monitoring instruments for the opening degree of the foundation surface are selected, a one-way joint meter radially arranged at an interface between dam foundation bed rock and a concrete dam body from an upstream surface to a downstream surface in a joint-crossing mode is selected.

An idea of calculating the opening degree of the foundation surface: a spatial distribution curve of current-period measured values of the one-way joint meter vertically arranged on the foundation surface is established, and the overall opening situation of the foundation surface is analyzed through a distribution probability of correlation coefficients of historical multi-period curves.

Specifically, a calculation method for the opening degree of the foundation surface is as follows.

A spatial correlation model Jₜ(x) of monitoring amounts and dam segment distribution is established according to current-period monitoring amounts x₁, x₂, . . . , xₙ of the joint meter on the same plane, and is used to embody the overall opening degree of the foundation surface. xₙ is the current-period monitoring amount of the joint meter n.

A Pearson correlation coefficient of spatial correlation models Jₜ and Jₜ₋₁ of historical monitoring amounts of the opening degree of the foundation surface in the previous periods is calculated through Formula (7), and a correlation coefficient r⁵ₜ of the spatial correlation curves of the overall opening degree of the foundation surface in adjacent two previous periods is obtained.

$${r}_{t}^{5} = \frac{C o v ( {J}_{t} , {J}_{t - 1} )}{\sqrt{[ D ( {J}_{t} ) ]} \sqrt{[ D ( {J}_{t - 1} ) ]}} \qquad ( 7 )$$

In the formula, Cov(Jₜ,Jₜ₋₁) is a covariance of Jₜ and Jₜ₋₁, and D(Jₜ) and D(Jₜ₋₁) are variances of J, and Jₜ₋₁ respectively.

Historical comparative analysis of the opening degree of the foundation surface: a time sequence prediction model is constructed by fitting correlation coefficients r⁵ₜ, r⁵ₜ₋₁, . . . , r⁵ₜ₋ₖ of historical spatial correlation curves of the opening degree of a joint face of the foundation surface. A current-period predicted value r⁵ₜ′ is compared to r⁵ₜ calculated according to actual measurement in the latest period, their difference value is judged by adopting the PauTa principle, and based on this, whether the overall opening degree of the joint face of the foundation surface in the current period has great change amplitudes compared to previous periods is quantitatively analyzed.

7. Analysis process of the overall opening degree of structural joints is as follows.

In order to prevent cracking of the dam body caused by tensile stress which may occur under the expansion of the volume of large-volume concrete itself and huge upstream water thrust, various types of structural joints such as transverse joints, longitudinal joints, and induced joints are disposed in the concrete dam. A calculation method for the overall opening degree of various structural joint surfaces in the dam body is studied so as to be used for analyzing the actual working conditions of the structural joints in the operation period.

When monitoring instruments for the opening degree of the structural joints are selected, a one-way joint meter radially arranged at a structural joint surface from an upstream surface to a downstream surface in a joint-crossing mode is selected.

An idea of calculating the opening degree of the structural joints: a spatial distribution curve of current-period measured values of the one-way joint meter vertically arranged on a structural joint plane is established, and the overall opening situation of the joint surface is analyzed through a distribution probability of correlation coefficients of historical multi-period curves.

Specifically, a calculation method for the opening degree of the structural joints is as follows.

A spatial correlation model Jₜ(x) of monitoring amounts and dam segment distribution is established according to current-period monitoring amounts x₁, x₂, . . . , xₙ of the joint meter on the same plane, and the overall opening degree of the structural joints is embodied. xₙ is the current-period opening degree monitoring amount of the joint meter n.

A Pearson correlation coefficient of spatial correlation models Jₜ and Jₜ₋₁ of historical monitoring amounts of the opening degree of the structural joints in the previous periods is calculated through Formula (8), and a correlation coefficient r⁶ₜ of the spatial correlation curves of the overall opening degree of the structural joints in adjacent two previous periods is obtained.

$${r}_{t}^{6} = \frac{C o v ( {j}_{t} , {j}_{t - 1} )}{\sqrt{[ D ( {j}_{t} ) ]} \sqrt{[ D ( {j}_{t - 1} ) ]}} \qquad ( 8 )$$

In the formula, Cov(Jₜ,Jₜ₋₁) is a covariance of Jₜ and Jₜ₋₁, and D(Jₜ) and D(Jₜ₋₁) are variances of J, and Jₜ₋₁ respectively.

Historical comparative analysis of the opening degree of the structural joints: a time sequence prediction model is constructed by fitting correlation coefficients r⁶ₜ, r⁶ₜ₋₁, . . . , r⁶ₜ₋ₖ of historical spatial correlation curves of the opening degree of the structural joint surfaces. A current-period predicted value r⁶ₜ′ is compared to r⁶ₜ calculated according to actual measurement in the latest period, their difference value is judged by adopting the PauTa principle, and based on this, whether the overall opening degree of the structural joint surfaces in the current period has great change amplitudes compared to previous periods is quantitatively analyzed.

8. Analysis process of the inter-layer micro deformation of the dam body is as follows.

When the concrete dam bears loads such as the self-weight of the dam, reservoir water and temperatures, concrete materials of the dam body will change over time, and then deform. Due to the material characteristics of concrete, a deformation magnitude between two upper and lower typical elevations of the dam body is small, and the deformation is usually not easy to find and monitor. A calculation method for deformation of a concrete layer between two typical elevations of the dam body of the dam is studied so as to be used for analyzing micro deformation between concrete layers of the dam body, thereby discovering potential trend changes occurring in the concrete materials caused by internal and external factors in advance.

When monitoring instruments for the inter-layer micro deformation of the dam body are selected: hydrostatic leveling points or artificial leveling points distributed on the dam crest and an in-dam inspection gallery at a typical elevation are selected.

An idea of calculating the inter-layer micro deformation of the dam body: a current-period height difference correlation curve of monitoring amounts of two upper and lower typical elevations of the dam body is established, and a micro deformation change trend of a certain layer of the dam body is analyzed through correlation coefficients of historical multi-period curves.

Calculation method for the inter-layer micro deformation of the dam body:
a micro deformation spatial correlation model gₜ(xₘₙ,fₘ) of the certain layer of the dam body is established according to a height difference xᵢⱼ between a current-period monitoring amount Eᵢ of upper typical-elevation leveling points and a current-period monitoring amount Eⱼ of lower typical-elevation leveling points of various dam segments as well as corresponding dam body layers A₁(x₁₁,f₁), A₂(x₁₂,f₁), . . . , A₁ₙ(x₁ₙ,f₁). xₘₙ is a vertical settlement deformation monitoring amount of monitoring points on a dam segment n of a layer m, and fₘ is the elevation corresponding to the monitoring points on the dam segment n of the layer m.

A Pearson correlation coefficient of spatial correlation models gₜ₋ₖ and gₜ₋₍ₖ₋₁₎ of historical monitoring amounts of overall settlement deformation of the dam body in the previous periods is calculated through Formula (9), and a correlation coefficient r⁷ₜ of the spatial correlation curves of the overall settlement deformation of the dam body in adjacent two previous periods is obtained.

$${r}_{t}^{7} = \frac{Cov ( {g}_{t - k} , {g}_{t - ( k - 1 )} )}{\sqrt{[ D ( {g}_{t - k} ) ]} \sqrt{[ D ( {g}_{t - ( k - 1 )} ) ]}} \qquad ( 9 )$$

In the formula, Cov(gₜ₋ₖ,gₜ₋₍ₖ₋₁₎ is a covariance of gₜ₋ₖ and gₜ₋₍ₖ₋₁₎, and D(gₜ₋ₖ) and D(gₜ₋₍ₖ₋₁₎ are variances of gₜ₋ₖ and gₜ₋₍ₖ₋₁₎ respectively.

Historical comparative analysis of the inter-layer micro deformation of the dam body: a time sequence prediction model is constructed by fitting correlation coefficients r⁷, r⁷ₜ₋₁, . . . , r⁷ₜ₋ₖ of historical spatial correlation curves of the inter-layer micro deformation of the dam body. A current-period predicted value r⁷ₜ′ is compared to r⁷ₜ calculated according to actual measurement in the latest period, their difference value is judged by adopting the PauTa principle, and based on this, whether the inter-layer micro deformation of the dam body in the current period has great change amplitudes compared to previous periods is quantitatively analyzed.

In summary, the analysis of the dam foundation deformation vertical distribution, the overall horizontal displacement of the dam body, the horizontal displacement coordination degree of the dam body, the overall deflection of the dam segment, the overall settlement of the dam body, the overall opening degree of the foundation surface and the overall opening degree of the structural joints in deformation analysis is completed.

Optionally, in S103, determining the seepage analysis result in the various indicator analysis results of the concrete dam based on the same-type multi-measuring-point monitoring data requires to determine the seepage analysis parameters of the concrete dam based on the seepage monitoring data in the same-type multi-measuring-point monitoring data, wherein the seepage analysis parameters include overall uplift pressure reduction of the dam foundation, a structural joint osmotic pressure gradient, a key area seepage change amplitude and overall anti-sliding stability of the dam foundation; and perform seepage analysis on the concrete dam based on the seepage analysis parameters to obtain the seepage analysis result.

In the following, analysis processes of the overall uplift pressure reduction of the dam foundation, the structural joint osmotic pressure gradient, the key area seepage change amplitude and the overall anti-sliding stability of the dam foundation in seepage analysis are introduced in details respectively.

1. Analysis process of the overall uplift pressure reduction of the dam foundation is as follows.

A high concrete dam forms a seepage field under the action of an upstream and downstream water level difference, so vertically upward uplift pressure will be produced. In order to lower uplift pressure of the dam foundation and improve the stability of the dam body, 1-2 anti-seepage curtains and 1-2 drainage curtain lines are distributed along the dam foundation to form a multi-layer anti-seepage system. A calculation method for the overall uplift pressure of the dam foundation is studied so as to be used for analyzing anti-seepage change situations of the dam foundation.

When monitoring instruments for uplift pressure of the dam foundation are selected, piezometer tubes distributed downstream of the anti-seepage curtains of the dam foundation and downstream of a basic drainage curtain line in an axial direction of the dam are selected.

An idea of calculating the overall uplift pressure of the dam foundation: dam foundation seepage control curtain lines are established respectively, specifically including downstream of an anti-seepage curtain (first seepage control curtain line), downstream of a first drainage curtain line (second seepage control curtain line) and downstream of a second drainage curtain line (third seepage control curtain line), correlation curves of uplift pressure reduction coefficients of piezometer tubes on various seepage control sections, change situations of the uplift pressure reduction coefficients of the various layers of seepage control curtain lines of the dam foundation are analyzed respectively through a distribution probability of correlation coefficients of historical multi-period curves, and based on this, an overall anti-seepage effect of the various layers of seepage control curtain lines of the various layers of the dam foundation is assessed respectively.

Specifically, a calculation method for the overall uplift pressure of the dam foundation is as follows.

According to the Hydraulic Design Handbook, osmotic strength of the seepage control curtain lines of the dam foundation is calculated through Formula (10):

$$P = {α}_{1} r H \qquad ( 10 )$$

In the formula, α₁ is an uplift pressure reduction coefficient, reflecting an anti-seepage effect; r is the volume weight of water, which is generally 9.81 kN/m³; and His an upstream and downstream water level difference of an arch dam.

If actually measured osmotic strength of a certain piezometer tube behind the anti-seepage curtain of the dam foundation (first seepage control curtain line) at a moment t is Pin, then the uplift pressure reduction coefficient at this monitoring point is calculated through Formula (11):

$${α}_{l n} = {P}_{l n} / rH \qquad ( 11 )$$

The uplift pressure reduction coefficients of various measuring points on a section of the anti-seepage curtain of the dam foundation are α₁₁, α₁₂, . . . , α₁ₙ, and a spatial correlation model fₜ(αₘₙ) is established, and is used to embody the overall anti-seepage condition of the anti-seepage curtain of the dam foundation (first seepage control curtain line). αₘₙ is the uplift pressure reduction coefficient of the piezometer tube on a dam segment n of an m^{th} layer of seepage control curtain line.

By adopting the Pearson correlation coefficient, the correlation of spatial correlation models fₜ₋ₖ and fₜ₋ₖ₋₁ of historical monitoring amounts of the uplift pressure reduction coefficients of the section of the anti-seepage curtain of the dam foundation in previous periods is calculated, and a correlation coefficient r⁸ₜ of spatial correlation curves of the uplift pressure reduction coefficients of the dam foundation in adjacent two previous periods is obtained.

Historical comparative analysis of the overall uplift pressure reduction effect of the dam foundation: a time sequence prediction model is constructed by fitting the correlation coefficients r⁸ₜ, r⁸ₜ₋₁, . . . r⁸ₜ₋ₖ of the spatial correlation curves of the uplift pressure reduction coefficients of the dam foundation. A current-period predicted value r⁸ₜ′ is compared to r⁸ₜ calculated according to actual measurement in the latest period, their difference value is judged by adopting the PauTa principle or the Grubbs principle or other methods, and based on this, whether the uplift pressure reduction coefficient of the dam foundation in the current period has abrupt changes or great change amplitudes compared to the last period is quantitatively analyzed, which is used to assess the overall seepage control effect of multiple layers of anti-seepage measures of the dam foundation.

2. Analysis process of the structural joint osmotic pressure gradient is as follows.

In order to prevent cracking of a heel caused by tensile stress which may occur under upstream huge hydraulic thrust, structural joints are arranged at positions of the heel close to an upstream dam surface of a high dam, especially a high arch dam. The structural joints are in a wet joint working state after water accumulation, and a calculation method for the structural joint osmotic pressure gradient is studied so as to be used for analyzing an osmotic pressure working condition of joint surfaces of the structural joints.

When monitoring instruments for osmotic pressure of the structural joints are selected, osmometers arranged on inner sides of annular drain tubes upstream and downstream of joint surface composite water stops of various dam segments from the upstream to the downstream are selected, 2 osmometers on each dam segment.

An idea of calculating the structural joint osmotic pressure gradient: by utilizing the osmometers distributed on the inner sides of the annular drain tubes upstream and downstream of the composite water stops of the structural joints in the current period, an osmotic pressure gradient of each dam segment is calculated, and osmotic pressure gradient curve fitting is performed along a dam axis by utilizing an osmotic pressure gradient value of each dam segment, so as to obtain an osmotic pressure gradient curve; and the change situation of the osmotic pressure gradient of the joint surfaces of the structural joints is analyzed through a distribution probability of correlation coefficients of historical multi-period osmotic pressure gradient curves.

Specifically, a calculation method for the structural joint osmotic pressure gradient is as follows.

In accordance with the Hydraulic Design Handbook, osmotic pressure strength is calculated according to Formula (12):

$$P = {α}_{2} rH \qquad ( 12 )$$

In the formula, α₂ is an osmotic pressure reduction coefficient, reflecting an anti-seepage effect; r is the volume weight of water, which is generally 9.81 kN/m³; and His an upstream and downstream water level difference of an arch dam.

If osmotic pressure strength which is actually measured by the osmometers in front of or behind the water stops of the structural joints of a dam segment n at a moment t is Pₙ₁ and Pₙ₂, corresponding osmotic pressure reduction coefficients are calculated through Formulas (13) and (14):

$${α}_{n 1} = {P}_{n 1} / rH \qquad ( 13 )$$

$${α}_{n 2} = {P}_{n 2} / rH \qquad ( 14 )$$

The osmotic pressure gradient is calculated through Formula (15):

$${f}_{n} ( α ) = ( {α}_{n 1} - {α}_{n 2} ) / {d}_{n 12} \qquad ( 15 )$$

In the formula, dₙ₁₂ is a distance between the two osmometers corresponding to the dam segment n.

A spatial correlation model Fₜ(f) of the osmotic pressure gradient and dam segment distribution is established according to the osmotic pressure gradients f₁, f₂, . . . , fₙ calculated through measured values of the structural joint osmometers, and is used to embody the overall osmotic pressure gradient of the structural joints. fₙ is an osmotic pressure gradient value of the joint surfaces of the structural joints on the dam segment n.

By adopting the Pearson correlation coefficient, the correlation of spatial correlation models Fₜ₋ₖ and Fₜ₋ₖ₋₁ of historical monitoring amounts of the osmotic pressure gradient curves of the structural joints along the dam axis in previous periods is calculated, and a correlation coefficient r⁹ₜ of the structural joint osmotic pressure gradients in adjacent two previous periods is obtained.

Historical comparative analysis of the structural joint osmotic pressure gradient: a time sequence prediction model is constructed by fitting correlation coefficients r⁹ₜ, r⁹ₜ₋₁, . . . , r⁹ₜ₋ₖ of structural joint osmotic pressure gradient paths. A current-period predicted value r⁹ₜ′ is compared to r⁹ₜ calculated according to actual measurement in the latest period, their difference value is judged by adopting the PauTa principle or the Grubbs principle or other methods, and whether the structural joint osmotic pressure gradient in the current period has abrupt changes or great change amplitudes compared to the last period is quantitatively analyzed, which is used to assess the overall seepage control effect of the structural joints.

3. Analysis process of the key area seepage change amplitude is as follows.

A large number of seepage monitoring instruments are distributed on the dam body and the dam foundation of the concrete dam and used to monitor a seepage amount of important parts and areas such as the dam body and the dam foundation, in a case that an absolute amount value of a seepage amount monitoring value is not large, change amplitudes of seepage monitoring points are compared, and based on this, a seepage change law of an arch dam is analyzed.

When monitoring instruments for seepage in important areas are selected, the seepage monitoring instruments distributed on the important parts such as the dam foundation and the dam body are selected.

An idea of comparatively calculating a seepage monitoring value change amplitude in the important areas: to avoid the impact on calculating precision due to gross errors of monitoring values caused by own accidental abnormalities of the monitoring points, an average seepage rate of current or recent monitoring values in multiple continuous times is compared to an average seepage rate of monitoring values in multiple continuous previous periods, and based on this, a monitoring value change amplitude situation of important seepage monitoring points is quantitatively analyzed.

Comparative calculation method for the seepage change amplitude in the important areas:
seepage monitoring amounts in n previous periods are selected, a derivative f′ₜ₊₁(x₁), f′ₜ₊₂(x₂), . . . , f′ₜ₊ₙ(xₙ) of the deformation monitoring amount in each period at a moment t is solved, and an average seepage rate in the n periods is calculated through Formula (16):

$${{f}^{′}}_{a v g} ( {x}_{n} ) = ( {{f}^{′}}_{t + 1} ( {x}_{1} ) + … {{f}^{′}}_{t + n} ( {x}_{n} ) ) / n \qquad ( 16 )$$

In the formula, xₙ is monitoring amounts of the important seepage monitoring points in n previous periods, wherein the n previous periods may be multiple continuous periods before the recent days or n periods under the similar working conditions in the last year or over the years; and f′_{avg}(xₙ) is the average seepage rate of the important seepage monitoring points in n previous periods.

According to properties of a certain important seepage monitoring point and recent working conditions, seepage monitoring amounts in the current period or recent m periods are selected, a derivative f′ₜ₊₁(x₁), f′ₜ₊₂(x₂), . . . , f′ₜ₊ₘ(xₘ) of the seepage monitoring amount in each period at a moment t is solved, and an average seepage rate in the current period or recent m periods is calculated through Formula (17):

$${{f}^{′}}_{a v g} ( {x}_{m} ) = ( {{f}^{′}}_{t + 1} ( {x}_{1} ) + … {{f}^{′}}_{t + m} ( {x}_{m} ) ) / m \qquad ( 17 )$$

In the formula, xₘ is the monitoring amounts of the important seepage monitoring point in the current period or recent m periods; and f′_{avg}(xₘ) is the average seepage rate of the important seepage monitoring point in the current period or recent m periods.

A change amplitude situation of the important seepage monitoring points in the current period or recent periods of the seepage monitoring values of the important monitoring points is calculated through Formula (18).

$${y}_{t} = {{f}^{′}}_{a v g} ( {x}_{m} ) / {{f}^{′}}_{a v g} ( {x}_{n} ) \qquad ( 18 )$$

Historical comparative analysis of the change amplitude of the important seepage monitoring points: a time-sequence prediction model is constructed by fitting monitoring point change situation quantized values yₜ, yₜ₋₁, . . . , yₜ₋ₖ. A current-period predicted value yₜ′ is compared to a monitoring point seepage change amplitude yₜ in the latest period, their difference value is judged by adopting the PauTa principle, and based on this, whether monitoring point seepage in the current period has great change amplitudes compared to previous periods is quantitatively analyzed.

4. Analysis process of the overall anti-sliding stability of the dam foundation is as follows.

A high concrete dam forms a seepage field under the action of an upstream and downstream water level difference, which will produce vertically upward uplift pressure, and the uplift pressure will lower friction between a concrete dam body and dam foundation rock mass, thus lowering anti-sliding stability of the dam foundation. A calculation method for the anti-sliding stability of the dam foundation is studied so as to be used for analyzing the anti-sliding stability of the dam foundation.

Selection of monitoring instruments for the anti-sliding stability of the dam foundation: piezometer tubes distributed downstream of the anti-seepage curtains of the dam foundation and downstream of a basic drainage curtain line in an axial direction of the dam are selected.

An idea of calculating the overall anti-sliding stability of the dam foundation: sliding conditions of dam foundation surfaces of various dam segments of a gravity dam are checked, an anti-sliding stability coefficient of the dam foundation surfaces is calculated according to a shear strength formula by adopting a rigid body limit equilibrium method, the dam foundation anti-sliding stability coefficients of the various dam segments constitute a correlation curve, a change situation of an overall anti-sliding stability coefficient of the dam foundation of the dam is analyzed through distribution of correlation coefficients of historical multi-period curves, and based on this, the overall anti-sliding stability of the dam foundation of the dam is assessed.

A calculation method for the anti-sliding stability of the dam foundation:

through a design drawing of the concrete dam, an axial width and a section area of an object dam segment are measured and calculated, and are used to calculate a volume of a certain dam segment i. A damming concrete volume weight is searched and determined in combination with design materials, and a self-weight Wᵢ is the certain dam segment is calculated through Formula (19):

$${W}_{i} = α rS \qquad ( 19 )$$

In the formula, a is the axial width of the dam segment, S is the section area of the dam segment; and r is the concrete volume weight.

Upstream and downstream water level measured data of the dam at present are acquired, and hydraulic thrust P in unit area in the current period is calculated by using a difference value between upstream and downstream water levels;

$$P = {r}_{w} {H}^{2} / 2 \qquad ( 20 )$$

In the formula, H is the upstream and downstream water level difference; and r_{w} is water density which is 9.81 kN/m³.

The piezometer tubes distributed downstream of the dam foundation anti-seepage curtain and downstream of the first and second basic drainage curtain lines of a certain dam segment i in an upstream-downstream direction of the dam segment are selected to calculate average uplift pressure Uᵢₐ in the current period at the bottom of the dam segment:

$${U}_{ia} = ( {U}_{i 1} + {U}_{i 2} + {U}_{i 3} ) / 3 \qquad ( 21 )$$

In the formula, Uᵢ₁ is uplift pressure downstream of the dam foundation anti-seepage curtain of the certain dam segment; Uᵢ₂ is uplift pressure downstream of the first drainage curtain line of the dam foundation of the certain dam segment i; and Uᵢ₃ is uplift pressure downstream of the second drainage curtain line of the dam foundation of the certain dam segment.

A current dam foundation anti-sliding stability coefficient K′ₛᵢ of the certain dam segment i is calculated by using a shear strength formula in design specifications:

$${K}_{si}^{′} = \frac{{f}^{′} ( \sum {W}_{i} - U ) + {c}^{′} A}{\sum P} \qquad ( 22 )$$

In the formula, f′ is an anti-shear friction coefficient of a contact surface of concrete with the dam foundation on the certain dam segment; c′ is anti-shear cohesive force of the contact surface of concrete with the dam foundation on the certain dam segment; and A is an interfacial area of the dam foundation contact surface on a certain segment.

The dam foundation anti-sliding stability coefficients of n dam segments of the dam are K′ₛ₁, K′ₛ₂, . . . , K′ₛₙ, and a spatial correlation model fₜ(K′ₛₙ) is established and used to embody the overall anti-sliding stability situation of the dam foundation of the dam.

By adopting the Pearson correlation coefficient, the correlation of spatial correlation models fₜ₋ₖ and fₜ₋ₖ₋₁ of historical calculating amounts of the overall anti-sliding stability coefficient of the dam foundation of the dam in previous periods is calculated, and a correlation coefficient r¹⁰ₜ of spatial correlation curves of the dam foundation anti-sliding stability coefficients in adjacent two previous periods is obtained.

Historical comparative analysis of the overall anti-sliding stability situation of the dam foundation: a time sequence prediction model is constructed by fitting the correlation coefficients r¹⁰ₜ, r¹⁰ₜ₋₁, . . . , r¹⁰ₜ₋ₖ of the spatial correlation curves of the anti-sliding stability coefficients of the dam foundation. A current-period predicted value r¹⁰ₜ′ is compared to r¹⁰ₜ calculated according to actual measurement in the latest period, their difference value is judged by adopting the PauTa principle or the Grubbs principle or other methods, and based on this, whether the overall anti-sliding stability coefficient of the dam foundation in the current period has abrupt changes or great change amplitudes compared to the last period is quantitatively analyzed, which is used to assess the overall anti-sliding stability of the dam foundation of the dam.

In summary, the analysis of the overall uplift pressure reduction coefficient, the structural joint osmotic pressure gradient, and the key area seepage change amplitude of the dam foundation in seepage analysis is completed.

Optionally, in S103, when the stress-strain analysis result in the various indicator analysis results of the concrete dam is determined based on the same-type multi-measuring-point monitoring data, it is required to determine stress-strain analysis parameters of the concrete dam based on the stress-strain monitoring data in the same-type multi-measuring-point monitoring data, wherein the stress-strain analysis parameters include dam foundation stress vertical distribution, an overall horizontal stress of the dam body, a vertical beam-direction overall stress and a special part strain measuring point change amplitude; and perform stress-strain analysis on the concrete dam based on the stress-strain analysis parameters to obtain the stress-strain analysis result.

In the following, analysis processes of the dam foundation stress vertical distribution, the overall horizontal stress of the dam body, the vertical beam-direction overall stress and the special part strain measuring point change amplitude in stress-strain analysis are introduced in details respectively.

1. Analysis process of the dam foundation stress vertical distribution is as follows.

When the concrete dam bears loads such as reservoir water, stresses borne by the dam body will be further conducted to dam foundation rock mass, especially for an arch dam, force on middle-lower portions of the dam body will be mostly conducted to the dam foundation, and thus a calculation method for the dam foundation stress vertical distribution of the dam is studied, which will be helpful for mastering working conditions of the dam foundation rock mass of the dam.

Monitoring instruments for the dam foundation stress vertical distribution: on dam foundations of representative dam segments of the concrete dam such as a middle riverbed dam segment, left and right bank slope dam segments and geological weak structures existing in the dam foundations, anchor rod stress gauges are distributed on anchor rods at equal intervals from a foundation surface to deep parts in dam foundation bed rock in combination with the arrangement of dam foundation anti-sliding anchor piles.

An idea of calculating the dam foundation stress vertical distribution: with the dam segments as units, a spatial distribution curve containing current-period measured values of vertical stresses and vertical depths of the dam foundation from top to bottom is established, and an overall change situation of the vertical stresses of the dam foundation is analyzed through a distribution probability of correlation coefficients of historical multi-period curves.

Specifically, a calculation model for the dam foundation stress vertical distribution:
measured values σ¹₁, σ¹₂, . . . , σ¹ₙ of the anchor rod stress gauges arranged on the same anchor rod at equal intervals are acquired, and a spatial correlation model Sₜ(σ¹ₙ) of monitoring amounts and dam foundation depth distribution is established, and used to embody a stress vertical distribution situation of a certain section of the dam foundation. σ¹ₙ denotes a current-period stress monitoring amount of a strain gauge n.

Afterwards, by adopting the Pearson correlation coefficient, the correlation of spatial correlation curves Sₜ and Sₜ₋₁ of historical monitoring amounts in adjacent two previous periods of the vertical stresses on any section of the dam foundation of the arch dam is calculated, and a correlation coefficient r¹¹ₜ of stress vertical distribution curves in every two adjacent previous periods is obtained.

Then, a first time sequence prediction model is constructed by fitting correlation coefficients r¹¹ₜ, r¹¹ₜ₋₁, . . . , r¹¹ₜ₋ₖ of the stress vertical distribution curves. A predicted value r¹¹ₜ′ of the first time sequence prediction model in the current period is compared to the correlation coefficient r¹¹ₜ of the stress vertical distribution curves calculated according to actual measurement in the latest period, their difference value is judged by adopting the PauTa principle, and whether the dam foundation stress vertical distribution in the current period on the section of the dam foundation has abrupt changes or a change amplitude exceeding a first preset threshold compared to previous periods is quantitatively analyzed so as to assess the overall change situation of the vertical stresses of the dam foundation.

The first preset threshold may be set based on the PauTa principle.

2. Analysis process of the overall horizontal stress of the dam body is as follows.

When the concrete dam bears loads such as reservoir water, the upper portion of the dam body bears large hydraulic thrust, and thus studying a calculation method for the overall horizontal stress at a typical elevation of the dam will meet the requirements of analyzing overall distribution of the horizontal stress of the concrete dam.

Monitoring instruments for the overall horizontal stress of the dam body: on typical dam segments on the riverbed and left and right banks, a five-directional strain gauge group or seven- or nine-directional strain gauge group is distributed on the different dam segments from the dam crest to horizontal sections corresponding to various typical elevations, and at the same time, no stress gauge is arranged, wherein, in the five-, seven- or nine-directional strain gauge group, strain gauges arranged horizontally and radially are selected as monitoring units for the overall horizontal stress of the dam body.

An idea of calculating the overall horizontal stress of the dam body: a spatial distribution curve with the same layer containing current-period measured values of the horizontal stress is established with the horizontal sections corresponding to the typical elevations as units, and a change situation of the overall horizontal stress at typical horizontal sections is analyzed through a distribution probability of correlation coefficients of historical multi-period curves. Specifically, a calculation model for the overall horizontal stress of the dam body:

uniaxial stresses σ²₁, σ²₂, . . . , σ¹ₙ converted from horizontal strain gauge measured values of the strain gauge group on the same plane are acquired, and a spatial correlation model Aₜ(σ²ₙ) of monitoring amounts and dam segment distribution is established, and used to embody an overall stress of a certain typical horizontal section. σ²ₙ denotes a current-period stress monitoring amount of a strain gauge n.

Afterwards, by adopting the Pearson correlation coefficient, the correlation of spatial correlation curves Aₜ and Aₜ₋₁ of historical monitoring amounts in adjacent two previous periods in a horizontal direction of any plane of an arch dam is calculated, and a correlation coefficient r¹²ₜ of the spatial correlation curves of the overall horizontal stress in every two adjacent previous periods is obtained.

Then, a second time sequence prediction model is constructed by fitting correlation coefficients r¹²ₜ, r¹²ₜ₋₁, . . . , r¹²ₜ₋ₖ of the horizontal stress spatial correlation curves. A predicted value r¹²ₜ′ of the second time sequence prediction model in the current period is compared to the correlation coefficient r¹²ₜ of the spatial correlation curves of the overall horizontal stress calculated according to actual measurement in the latest period, their difference value is judged by adopting the PauTa principle, and whether the overall horizontal stress in the current period has abrupt changes or a change amplitude exceeding a second preset threshold compared to previous periods is quantitatively analyzed so as to assess the change situation of the overall horizontal stress of the dam body.

The second preset threshold may be set based on the PauTa principle.

3. Analysis process of the vertical beam-direction overall stress is as follows.

According to structural stress and load distribution of the dam, when the concrete dam bears loads such as reservoir water, the middle-lower portion of the dam body mainly bears beam-direction force, and thus a calculation method for the vertical beam-direction overall stress of an arch dam is studied to achieve the analysis of the overall stress on vertical beam-direction sections of typical dam segments of the dam.

Monitoring instruments for the vertical beam-direction stress: on representative dam segments of the concrete dam such as a middle riverbed dam segment, left and right bank slope bank segments, and geological weak structures existing in the dam foundation, a five-directional strain gauge group or seven- or nine-directional strain gauge group is distributed on the different dam segments from the dam crest to various key horizontal sections, and at the same time, no stress gauge is arranged, wherein, in the five-, seven- or nine-directional strain gauge group, strain gauges arranged vertically are selected as monitoring units for the vertical beam-direction stress.

An idea of calculating the vertical beam-direction stress: with vertical sections of the dam segments as units, a spatial distribution curve containing current-period measured values of vertical stresses and elevations from top to bottom is established, and an overall stress change situation of the beam-direction sections is analyzed through a distribution probability of correlation coefficients of historical multi-period curves.

Specifically, a calculation model for the beam-direction overall stress:
uniaxial stresses σ³₁, σ³₂, . . . , σ³ₙ converted from vertical strain gauge measured values of the strain gauge group on the same section are acquired, and a spatial correlation model Bₜ(σ³ₙ) of monitoring amounts and elevation distribution is established, and used to embody an overall stress of a certain beam-direction section. σ³ₙ denotes a current-period stress monitoring amount of a strain gauge n.

Afterwards, by adopting the Pearson correlation coefficient, the correlation of spatial correlation curves Bₜ and Bₜ₋₁ of historical monitoring amounts in adjacent two previous periods on a vertical beam-direction section of any dam segment of the dam is calculated, and a correlation coefficient r¹³ₜ of the spatial correlation curves of the vertical beam-direction overall stress in every two adjacent periods is obtained.

Then, a third time sequence prediction model is constructed by fitting correlation coefficients r¹³ₜ, r¹³ₜ₋₁, . . . , r¹³ₜ₋ₖ of the spatial correlation curves of the vertical beam-direction overall stress.

A predicted value r¹³ₜ′ of the third time sequence prediction model in the current period is compared to the correlation coefficient r¹³ₜ of the spatial correlation curves of the vertical beam-direction overall stress calculated according to actual measurement in the latest period, their difference value is judged by adopting the PauTa principle, and whether the beam-direction overall stress in the current period has abrupt changes or a change amplitude exceeding a third preset threshold compared to previous periods is quantitatively analyzed so as to assess the overall stress change situation of the beam-direction sections.

The third preset threshold may be set based on the PauTa principle.

4. Analysis process of the special part strain measuring point change amplitude is as follows.

A large number of strain monitoring instruments are distributed on the dam body and the dam foundation of the concrete dam, and used to monitor and discover stress concentration of the dam body from the microscopic perspective and predict parts where local cracking is prone to occurring, and in the case that a strain monitoring absolute amount value is not large, studying and analyzing a change rate of strain measuring points will be helpful for discovering and mastering a strain change law of special parts of the dam body in time, providing support to discover micro defects of the dam body as early as possible.

Important strain monitoring instruments refer to strain gauges deployed on stress concentration parts such as heels and toes of the dam and used to predict parts where local cracking is prone to occurring or concrete defects have been discovered.

An idea of calculating the strain rate of the measuring points: to prevent gross errors of monitoring values caused by own accidental abnormalities of the measuring points, a ratio of an average value of current or recent monitoring values in multiple continuous times to an average value of monitoring values in multiple continuous previous periods is adopted to analyze a change rate situation of the monitoring values of the important strain measuring points.

Specifically, a calculation model for the strain rate of the measuring points:
an average stress monitoring amount in historical periods of time corresponding to pre-arranged key parts is acquired. Specifically, strain monitoring amounts ε₁, ε₂, . . . , εₙ of the key parts in previous periods are selected, and an average amount ε_{navg} of monitoring in n periods is calculated. εₙ denotes monitoring amounts of the strain measuring points of the key parts in n previous periods, the n previous periods may be multiple continuous periods before the recent days or n periods under the similar working conditions in the last year or over the years; and ε_{navg} denotes the average amount of monitoring of the strain measuring points of the key parts in n previous periods.

Then, a stress monitoring amount in each period within a current period of time corresponding to the key parts is acquired. It is assumed that the current period of time contains m periods, strain monitoring amounts ε₁′, ε₂′, . . . , εₘ′ corresponding to the key parts in the m periods are selected to calculate an average amount ε_{mavg}′ of monitoring in the m periods. εm denotes a monitoring amount of the m^{th} time at present or in recent days of the strain measuring points of the key parts; and ε_{mavg} denotes an average amount of monitoring in recent m periods of the strain measuring points of the key parts.

Then, a plurality of strain rates corresponding to the key parts are acquired on the basis of the average stress monitoring amount in the historical periods of time and the stress monitoring amount in each period within the current period of time. Specifically, a current strain rate of the important measuring points is calculated by adopting yₜ=εₘ′/ε_{navg}, or strain rates in multiple recent periods of the important measuring points are calculated by using yₙ=ε_{mavg}′/ε_{navg}.

Then, a fourth time sequence prediction model is constructed by fitting the strain rates yₜ, yₜ₋₁, . . . yₜ₋ₖ. Then, a predicted value yₜ′ of the fourth time sequence prediction model in the current period is compared to the strain rate yₜ calculated according to actual measurement in the latest period, their difference value is judged by adopting the PauTa principle, and whether the strain rate in the current period has abrupt changes or a change amplitude exceeding a fourth preset threshold compared to previous periods is quantitatively analyzed to assess a monitoring value change rate situation of the important strain measuring points.

The fourth preset threshold may be set based on the PauTa principle.

In summary, the analysis of the dam foundation stress vertical distribution, the overall horizontal stress of the dam body, the vertical beam-direction overall stress and the special part strain measuring point change amplitude in stress-strain analysis is completed.

Optionally, in S103, determining the temperature analysis result in the various indicator analysis results of the concrete dam based on the same-type multi-measuring-point monitoring data requires to determine temperature analysis parameters of the concrete dam based on the temperature monitoring data in the same-type multi-measuring-point monitoring data, wherein the temperature analysis parameters include dam foundation temperature distribution and a dam body temperature gradient; and perform temperature analysis on the concrete dam based on the temperature analysis parameters to obtain the temperature analysis result.

In the following, analysis processes of the dam foundation temperature distribution and the dam body temperature gradient in temperature analysis are introduced in details respectively.

1. Analysis process of the dam foundation temperature distribution is as follows.

Temperatures of deep portions and shallow portions of dam foundation rock mass of the dam and a dam body temperature influence each other, then an operation working condition of the dam body is impacted by temperature loads, and thus monitoring a dam foundation ground temperature by using temperature gauges arranged vertically on the dam foundation will be helpful for mastering a dam foundation temperature distribution situation of the dam.

Monitoring instruments for the dam foundation temperature: consistent with representative temperature monitoring dam segments of the dam body, temperature gauges are vertically arranged from an interfacial surface of the dam body and the dam foundation to the deep portion of the dam foundation rock mass from top to bottom so as to monitor a change situation of the dam foundation ground temperature in the operation period.

An idea of calculating the dam foundation temperature: with vertical sections of the dam segments as units, a spatial distribution curve containing current-period measured values of vertical temperatures and elevations from top to bottom is established, and an overall temperature change situation of the vertical sections of the dam foundation is analyzed through a distribution probability of correlation coefficients of historical multi-period curves. Specifically, a calculation model for the dam foundation temperature:

a spatial correlation model Tₜ of monitoring amounts and elevation distribution is established according to measured values T₁, T₂, . . . , Tₙ of the temperature gauges on the same section, and used to embody vertical temperature distribution of a certain temperature monitoring section of the dam foundation. Tₙ is a current-period temperature monitoring amount of the temperature gauge n.

By adopting the Pearson correlation coefficient, the correlation of spatial correlation curves Tₜ and Tₜ₋₁ of historical monitoring amounts of a certain temperature monitoring section of the dam foundation in previous periods is calculated, and a correlation coefficient r¹⁴ₜ of the spatial correlation curves of the certain temperature monitoring section of the dam foundation in adjacent two times is obtained.

Historical comparative analysis of dam foundation temperature calculation: a time sequence prediction model is constructed by fitting correlation coefficients r¹⁴ₜ, r¹⁴ₜ₋₁, . . . , r¹⁴ₜ₋ₖ of historical spatial correlation curves of the certain temperature monitoring section of the dam foundation. A current-period predicted value r¹⁴ₜ′ is compared to r¹⁴ₜ calculated according to actual measurement in the latest period, their difference value is judged by adopting the PauTa principle, and based on this, whether the dam foundation temperature in the current period has great change amplitudes compared to previous periods is quantitatively analyzed.

2. Analysis process of the dam body temperature gradient is as follows.

In the operation period of the concrete dam, besides upstream water loads, the temperature load is also a main influence factor of operation working conditions of the dam body, and thus conducting long-term operation temperature monitoring of the dam body by using temperature gauges which are originally used for concrete temperature control in a construction period of the dam will be helpful for mastering a temperature distribution situation of the dam body of the arch dam.

Monitoring instruments for the dam body temperature: temperature gauges having the same spacing are distributed from the upstream to the downstream along a monitoring line on the same plane of the various dam segments, and 2-7 temperature gauges are distributed in total according to a width of the dam body.

An idea of calculating the dam body temperature gradient: by utilizing the temperature gauges having the same spacing distributed from the upstream to the downstream along the monitoring line on the same plane of the various dam segments, temperature gradients at the current elevation of the various dam segments are calculated respectively, and temperature gradient curve fitting is performed along a dam axis by utilizing a temperature gradient value of each dam segment, so as to obtain a temperature gradient curve; and a change situation of the temperature gradients at the current elevation of the dam segments is analyzed through a distribution probability of correlation coefficients of historical multi-period temperature gradient curves.

Specifically, a calculation model for the dam body temperature gradient:
if measured temperatures of the temperature gauges distributed from the upstream to the downstream on a plane at a certain elevation m of a dam segment n at a moment t are Tₙₘ₁, Tₙₘ₂, . . . , Tₙₘᵢ respectively, a temperature gradient is g(T)=(Tₙₘ₁−Tₙₘᵢ)/(i−1)dₙₘ, wherein dₙₘ is an average distance between every two distributed temperature gauges on the plane at the certain elevation m of the dam segment n.

A spatial correlation model Gₜ(g) of the temperature gradients and dam segment distribution is established according to temperature gradients g₁ₘ, g₂ₘ, . . . , gₙₘ calculated according to the measured values of the temperature gauges on the plane at the same elevation, and used to embody an overall temperature gradient of a plane at a certain elevation of the dam body. gₙₘ is a temperature gradient value of the plane at the certain elevation m of the dam segment n.

By adopting the Pearson correlation coefficient, the correlation of spatial correlation models Gₜ₋ₖ and Gₜ₋ₖ₋₁ of historical monitoring amounts of the temperature gradient curves along the dam axis on the plane at a certain elevation m in previous periods is calculated, and a correlation coefficient r¹⁵ₜ of the temperature gradients in adjacent two previous periods is obtained.

Historical comparative analysis of the dam body temperature gradient: a time sequence prediction model is constructed by fitting correlation coefficients r¹⁵ₜ, r¹⁵ₜ₋₁, . . . , r¹⁵ₜ₋ₖ of the dam body temperature gradient. A current-period predicted value r¹⁵ₜ is compared to r¹⁵ₜ calculated according to actual measurement in the latest period, their difference value is judged by adopting the PauTa principle or the Grubbs principle or other methods, and whether the temperature gradient in the current period has abrupt changes or great change amplitudes compared to the last period is quantitatively analyzed, which is used to assess the dam body temperature distribution situation.

Optionally, in S104, when any scoring result in the deformation scoring result, the seepage scoring result and the stress-strain scoring result of the concrete dam is determined based on the multi-type multi-measuring-point monitoring data, it is required to perform region division on the key parts in concrete dam operation, and acquire time-sequence measured value data of different types of monitoring instruments in a certain region from the multi-type multi-measuring-point monitoring data; establish map structures for the time-sequence measured value data in time dimension and variable dimension respectively to obtain a time feature map and a variable feature map; input the time feature map and the variable feature map into a time map attention network and a variable map attention network respectively to obtain a time attention matrix and a variable attention matrix; splice and input the time-sequence measured value data, the time attention matrix and the variable attention matrix into a gating convolutional network to obtain target features; and calculate abnormal scores according to the target features, and compare the abnormal scores with preset indicator thresholds to obtain the operation scoring results of the corresponding indicators of the concrete dam.

The step of calculating the abnormal scores according to the target features includes: inputting the target features into a predicting module and a reconstructing module to obtain a prediction value and a reconstruction probability; and calculating the abnormal scores according to the prediction value and the reconstruction probability.

The predicting module is a multilayer perceptron.

The reconstructing module includes an arbiter and an autoencoder.

S104 is specifically introduced below in combination with model maps.

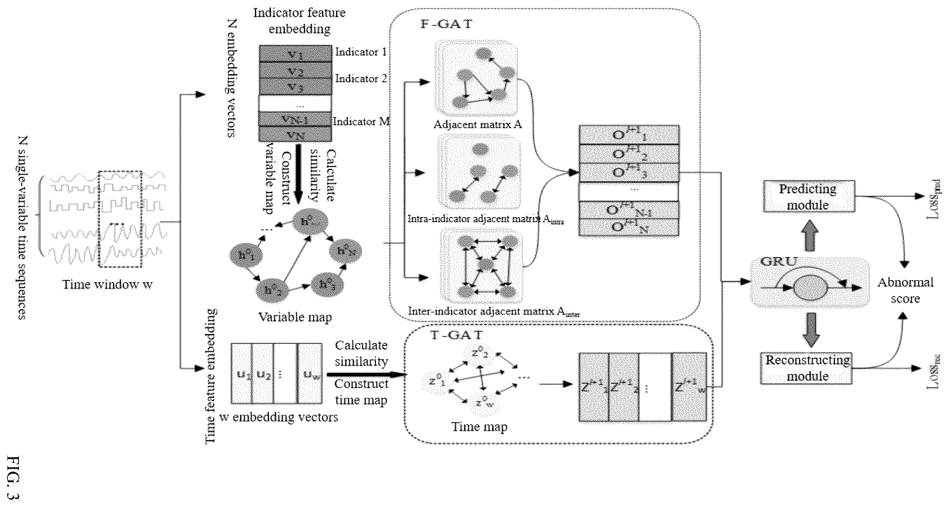

FIG. 3 is a schematic diagram of a multi-indicator map attention network model framework of key parts of a concrete dam shown in the present application. As shown in FIG. 3, a map structure is constructed first by using multivariate time-sequence measured value data of multiple types of monitoring instruments, and the map structure specifically includes a map structure learning layer, a map attention layer and a united network layer. The map structure learning layer represents inherent properties of each node (i.e. monitoring point) through embedding vectors, constructs map structures in time dimension and variable dimension respectively, and captures a time and variable dimension dependency of the multivariate time-sequence data. The map attention layer further learns and represents this dependency, and captures linear and nonlinear dependencies within and between indicators through an improved attention mechanism. Finally, the advantages of prediction module and reconstruction module are combined through the united network layer, prediction errors and reconstruction probabilities are used as abnormal scores to detect abnormalities, and an attention score is used to locate the indicators most likely to cause operation abnormalities of the dam.

Monitoring data collected by the multiple types of monitoring instruments for a certain monitoring effect value in a certain area are called the multivariate time-sequence data, which consists of n groups of univariate time-sequence data, and these data are interrelated through linear and nonlinear relationships. After an abnormality occurs in the operation of a certain part region of the concrete dam, it is manifested as a change of all and part of the monitoring data in the time dimension. Therefore, for monitoring data within the same time window, two map structures are used to model association relationships between the time dimension and variable dimension separately, specifically as follows.

(1) Variable feature map. Before constructing the variable feature map, it is necessary to randomly initialize a representation vector for each variable to reduce the decrease in model accuracy caused by different data types and value ranges. In an implicit representation space composed of embedding vectors, the vectors that are closer in distance are more similar, and the correlation between their corresponding variables (i.e.: the correlation between different types of concrete dam safety monitoring instruments) is stronger. Map attention networks require data with explicit map structures as an input, so N variables within an input time window are used as N nodes to construct the map structure. Firstly, a similarity relationship between nodes is calculated according to initial representation vectors of the nodes. Then, the largest number of node pairs are selected and connected by edges to obtain a sparse directed map structure. Specific steps are as follows.

First, an embedding vector vₜ∈v [symbol] ^{d}, i∈{1, 2, . . . , N} is set for each variable, wherein d denotes the dimension of the vector, and different values are set according to the actual situation. An initial value of each vector is randomly given, and the specific values are obtained by being continuously adjusted through backpropagation in the training process of the models. The correlation of the variables may be calculated through the embedding vectors. For variables i and j, the correlation is calculated through (23):

$${e}_{j i} = f ( {v}_{i} , {v}_{j} ) = \frac{{v}_{j}^{T} {v}_{j}}{P {v}_{i} P \cdot {Pv}_{j} P} \qquad ( 23 )$$

In the formula, f(vᵢ,vⱼ) is any method of calculating the similarity, and if a directed map is to be constructed, an asymmetric similarity calculation method is required, and a cosine similarity is used to calculate the similarity. After every two of all the variables are combined to calculate the similarity, for any variable i, top K neighboring variables j having the highest similarity with the variable are selected, in a spatial map, i and j are connected by edges, and a column where i is located in a corresponding spatial adjacent matrix A is represented by Formula (24):

$${A}_{j i} = \{ \begin{matrix}1 & if j ∈ Top K ( \{ {e}_{ki} : k ∈ \{ 1 , 2 , … , N \} \} ) \\ 0 & else\end{matrix} \qquad ( 24 )$$

The value of K may be given by a user according to specific situations to adjust the sparsity of the maps. In a case of having priori information about the map structure, the adjacent matrix A may be directly given by the user. In some special scenarios, the adjacent matrix may be set to be a matrix with all values being 1, namely constructing a fully connected map.

(2) Time feature map. To explicitly model temporal information between data, a time feature map within the input time window is constructed using steps similar to those used to construct the variable feature map mentioned above. There are differences between a time map and a variable map in setting and composition manner of embedding vectors. In the variable map, the embedding vectors are to reduce the impact of different variable data types and value ranges on model precision. In the time feature map, in addition to assuming a corresponding embedding vector for each time point within a sliding window, it is also necessary to introduce positional encoding to represent temporal and positional differences of the data. The embedding vector of each node is, uᵢ∈ [symbol] ^{d′}, i∈{1, 2, . . . , ω} an initial value of uᵢ is also randomly given, and then final representations are obtained through training and learning.

For a time sequence in an input sliding window, a positional code p\vec{e}ⱼ⁽ⁱ⁾ is given to a vector at any time stamp j, and it is calculated through Formula (25):

$$p {\vec{e}}_{j}^{( i )} = {f ( j )}^{i} := \{ \begin{matrix}sin ( {ω}_{k} \cdot j ) , & if i = 2 k , \\ cos ( {ω}_{k} \cdot j ) , & if i = 2 k + 1\end{matrix} \qquad ( 25 )$$

$${ω}_{k} = \frac{1}{100 {0}^{2 k / d}}$$

In the formula, dis the dimension of the positional code, and needs to be the same as the dimension of a variable at the current position, namely d=N, and d further needs to be a multiple of 2. Unlike in the above variable feature map where each variable is treated as a node, in order to construct an explicit time map structure, it is necessary to treat data at each moment as a node in the map. A specific form of the positional code is calculated through Formula (26):

$$p {\vec{e}}_{j} = {[ \begin{matrix}sin ( {ω}_{1} \cdot t ) \\ cos ( {ω}_{1} \cdot t ) \\ sin ( {ω}_{2} \cdot t ) \\ cos ( {ω}_{2} \cdot t ) \\ ⋮ \\ sin ( {ω}_{N / 2} \cdot t ) \\ cos ( {ω}_{N / 2} \cdot t )\end{matrix} ]}_{N \times 1} \qquad ( 26 )$$

After assigning the positional code to each time point, a time map is constructed by calculating the similarity between embedding vectors at different time points. It is calculated through Formula (27):

$${e}_{ji}^{′} = f ( {u}_{i} , {u}_{j} ) = \frac{{u}_{i}^{T} {u}_{j}}{‖ {u}_{i} ‖ \cdot ‖ {u}_{j} ‖} \qquad ( 27 )$$

The pairwise similarity between the different time points represents the degree of similarity between different time stamps. When constructing the time map, similar to constructing the variable map above, for data i at any time stamp, K neighboring time points j having the highest similarity with the data are selected and connected by edges. A constructed time adjacent matrix is calculated through Formula (28):

$${A}_{ji}^{′} = \{ \begin{matrix}1 & if j ∈ Top K ( \{ {e}_{ki}^{′} : k ∈ \{ 1 , 2 , … , ω \} \} ) \\ 0 & else\end{matrix} \qquad ( 28 )$$

In the formula, A′∈ [symbol] ^{ω×ω}, and the value of K is also specified by the user and is generally the same as the sparsity of the spatial adjacent matrix.

After completing the construction of the map structure data, the map attention networks are used to learn information in time dimension and variable dimension. After learning, each node in the map structures will obtain a final representation vector, which contains information of current nodes and theirs neighboring nodes. The map attention layer consists of the parallel variable map attention network and time map attention network, and is used to simultaneously capture the dependencies in different dimensions in the data. Meanwhile, by improving the attention mechanism in the variable map attention layer, the correlation of the indicators in the data is explicitly captured, specifically as follows.

(1) Variable map attention network (F-GAT). The constructed variable feature map is used as an input of the F-GAT, and information in the map is further excavated through the attention mechanism. First, it is assumed that a feature of the F-GAT at an l^{th} layer is represented as H^{l}, which is initially input into Formula (29):

$${H}^{0} = ( \hat{X} {W}_{i n} ) ‖ V \qquad ( 29 )$$

In the formula, \hat{X}=[x_{t-ω+1}, x_{t-ω+2}, . . . , xₜ]∈ [symbol] ^{N×ω} is an input sequence with a length of ω at a time stamp t, Wᵢₙ∈ [symbol] ^{θ×d} is a learnable transformation matrix of input data, ∥ is a splicing operation, and V is a matrix composed of node representing vectors.

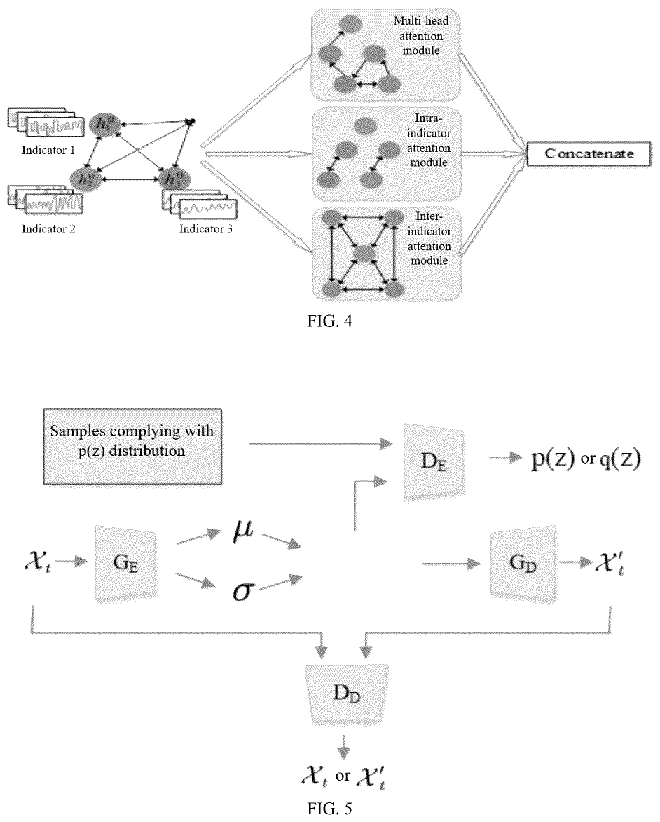

The architecture of the F-GAT is as shown in FIG. 4, consisting of three modules: multi-head attention, intra-indicator attention, and inter-indicator attention. The multi-head attention module mainly models variable dependencies between multivariate time sequences, while the intra-indicator attention and the inter-indicator attention are used to capture the indicator correlation between different time sequences. Specifically, intra-indicator correlation refers to the correlation of all measuring points under the same type of monitoring instrument. For example, the concrete dam deformation monitoring item includes multiple types of monitoring instruments such as the direct plumb lines, surface deformation observations, hydrostatic leveling, and the joint meters, and a range within indicators refers to all measuring points included in the type of monitoring instrument such as the direct plumb lines. Inter-indicator correlation is the correlation of different type of monitoring instruments. For example, the concrete dam deformation monitoring item includes multiple types of monitoring instruments such as the direct plumb lines, surface deformation observations, hydrostatic leveling, and the joint meters, and a range between indicators is the multiple types of monitoring instruments such as direct plumb line measuring points, surface deformation observation points, hydrostatic leveling points and the joint meters.

The multi-head attention module updates the feature representation of each node by aggregating information of neighboring nodes of a target node, and it is calculated through Formula (30):

$${h}_{{att}_{i}}^{l + 1} = {‖}_{s = 1}^{S} {\sum }_{j ∈ {N}_{i}} {α}_{ij}^{l s} {W}_{a t t}^{l s} {h}_{j}^{l} \qquad ( 30 )$$

In the formula, hₐₜₜ_{ᵢ}^{l+1} is a feature representation of the node i at a layer l+1, ∥ is a, splicing operation, S represents the number of attention heads, αᵢⱼ^{ls} represents attention scores of the node i and the node j at the sₜₕ attention head in a layer l, Wₐₜₜ^{ls} is a learnable weight matrix of the sₜₕ attention head in the layer l, hⱼ^{l}∈H^{l} is a feature representation of the node j at the layer l, and [symbol] ᵢ={j|Aᵢⱼ>0} is a set of neighboring nodes of the node i in the above adjacent matrix A representing the variable feature map. The attention scores are calculated through Formula (31), Formula (32) and Formula (33):

$${a}_{i j}^{l s} = attention ( i , j ) = \frac{exp ( π ( i , j ) )}{{\sum }_{k ∈ N ( i ) ⋃ \{ i \}} exp ( π ( i , k ) )} \qquad ( 31 )$$

$$π ( i , j ) = LeakyReLU ( {a}^{T} ( {g}_{i}^{l s} \vert {g}_{i}^{ls} ) ) \qquad ( 32 )$$

$${g}_{i}^{l s} = {v}_{i} ‖ {W}_{att}^{l s} {h}^{l} \qquad ( 33 )$$

In the formulas, a^{T} is a learnable bias vector, ∥ is a splicing operation, and LeakyReLU is a nonlinear activation function.

Traditional map attention networks fail to consider the indicator correlation existing in the multivariate time sequence, and thus some important information in the variable dimension is lost. Neighboring nodes having different dependencies have different influences on a central node. In this section, the effectiveness of the models for modeling of the variable dependencies between sequences is improved by adding the two relation attention modules, namely the intra-indicator attention and the inter-indicator attention. Adjacent matrices of an intra-indicator attention map and an inter-indicator attention map are defined through Formula (34) and Formula (35):

$${A}_{intra}^{ij} = \{ \begin{matrix}1 , j ∈ {C}_{intra}^{i} \\ 0 , else\end{matrix} \qquad ( 34 )$$

$${A}_{inter}^{ij} = \{ \begin{matrix}1 , j ∈ {C}_{inter}^{i} \\ 0 , else\end{matrix} \qquad ( 35 )$$

In the formulas, Cᵢₙₜᵣₐⁱ={j|mᵢ=mⱼ} and Cᵢ^{inter}={j|mᵢ≠mⱼ} are candidate sets, that is, Cᵢₙₜᵣₐⁱ represents nodes belonging to the same indicator as the node i, and Cᵢ^{inter} represents nodes different from the node i in monitoring indicator. It is to be noted that, when |Cᵢₙₜᵣₐⁱ|>K or |Cᵢ^{inter}|>K, it is necessary to select top K indicators with the highest cosine similarity by using a TopK operation to construct the adjacent matrices.

Then, multi-indicator correlation between different time sequences is clearly captured through the two relation attention modules. Features of the intra-indicator attention module are calculated through Formula (36), Formula (37) and Formula (38):

$${h}_{intr {a}_{i}}^{l + 1} = {\sum }_{j ∈ {𝒩}_{{intra}_{i}}} {β}_{{intra}_{i}}^{lj} {W}_{intra}^{l} {h}_{j}^{l} \qquad ( 36 )$$

$${β}_{i n t r {a}_{j}}^{l j} = \frac{exp ( {g}_{i n t r a}^{l j} )}{{\sum }_{k ∈ {𝒩}_{{intra}_{i}}} exp ( {g}_{{intra}_{i}}^{l k} )} \qquad ( 37 )$$

$${g}_{i n t r {a}_{i}}^{l j} = σ ( ReLU ( ( {v}_{i} ‖ {v}_{j} ) {W}_{intra 1}^{l} + {b}_{i n t r a 1}^{l} ) {W}_{i n t r a 2}^{l} ) \qquad ( 38 )$$

In the formulas, hᵢₙₜᵣₐ_{ᵢ}^{l+1} is a feature representation of the node i at a layer l+1, [symbol] ᵢₙₜᵣₐ_{ᵢ}={j|Aᵢₙₜᵣₐ^{ij}>0} is an intra-indicator neighboring node set of the node i, βᵢₙₜᵣₐ_{ᵢ}^{ij} is attention scores of the node i and the node j at a layer l, Wᵢₙₜᵣₐ_{ₗ}, Wᵢₙₜᵣₐ₁_{ₗ}, and Wᵢₙₜᵣₐ₂^{l} are weight matrices of the layer l, and bᵢₙₜᵣₐ₁_{ₗ} is a bias vector of the layer l. Similarly, a feature representation hᵢₙₜₑᵣ_{ᵢ}^{l+1} of the inter-indicator attention module may be calculated, wherein [symbol] ᵢₙₜₑᵣ_{ᵢ}={j|Aᵢₙₜₑᵣ_{ᵢⱼ}>0} is an inter-indicator neighboring node set of the node i. A final output hᵢ^{l+1} of the variable map attention layer is obtained by splicing inputs of three attention modules, and is calculated through Formulas (39) and (40):

$${h}_{i}^{l + 1} = R e L U ( {W}_{out}^{l + 1} {o}_{i}^{l + 1} + {b}_{o u t}^{l + 1} ) \qquad ( 39 )$$

$${o}_{i}^{l + 1} = {h}_{a t {t}_{i}}^{l + 1} ‖ {h}_{i n t r {a}_{i}}^{l + 1} ‖ {h}_{i n t e {r}_{i}}^{l + 1} \qquad ( 40 )$$

In the formulas, hᵢ^{l+1} is a final representation of the node i at the layer l+1, Wₒᵤₜ^{l+1} represents a weight matrix of the layer l+1, bₒᵤₜ^{l+1} represents a bias vector of the layer l+1, ∥ is a splicing operation, and oᵢ^{l+1} is obtained by splicing intermediate features hₐₜₜ_{ᵢ}^{l+1}, hᵢₙₜᵣₐ_{ᵢ}^{l+1}, and hᵢₙₜₑᵣ_{ᵢ}^{l+1}, at the layer l+1.

(2) Time map attention network (T-GAT). It is assumed that Z^{l} is a feature representation of the T-GAT at a layer l, and an initial input of the T-GAT is Z⁰=(\hat{X}W′ᵢₙ)∥U, wherein W′ᵢₙ∈ [symbol] ^{d×ω} is a learnable transformation matrix of input data, and U is a matrix composed of node representing vectors. The time map attention layer uses the above constructed time map structure as an input, and updates a feature representation of each time point by aggregating information of neighboring nodes by utilizing the multi-head attention module in combination with positional encoding, and it is calculated through Formula (41):

$${z}_{i}^{l + 1} = {‖}_{s = 1}^{S} {\sum }_{j ∈ 𝒩 ( i ) ⋃ \{ i \}} {a}_{i j}^{{ls}^{′}} {W}_{a t t}^{{ls}^{′}} p {\vec{e}}_{j} {z}_{\dot{j}}^{l} \qquad ( 41 )$$

In the formula, zᵢ^{l+1} is a feature representation of a node i at a layer l+1, ∥ is a splicing operation, S represents the number of attention heads, [symbol] ᵢ={j|A′ᵢⱼ>0} is a set of neighboring nodes of the node i in an adjacent matrix A′ representing the time map above, aᵢⱼ^{ls′} is attention scores of the node i and a node j at the sₜₕ attention head in the layer l, Wₐₜₜ^{ls′} is a weight matrix of the sₜₕ attention head in the layer l, zⱼ^{l}∈Z^{l} is a feature representation of the node j at the layer l, and calculation steps for aᵢⱼ^{ls′} are similar to those for aᵢⱼls above, which are calculated specifically through Formula (42), Formula (43) and Formula (44):

$${a}_{i j}^{{ls}^{′}} = \frac{exp ( π ( i , j ) )}{{\sum }_{k ∈ 𝒩 ( g ) ⋃ \{ i \}} exp ( π ( i , k ) )} \qquad ( 42 )$$

$$π ( i , j ) = LeakyReLU ( {a}^{T} ( {c}_{i}^{l s} ‖ {c}_{j}^{l s} ) ) \qquad ( 43 )$$

$${c}_{i}^{ls} = {u}_{i} ‖ {W}_{a t t}^{l {s}^{′}} p {\vec{e}}_{i} {z}^{l} \qquad ( 44 )$$

In the formulas, aᵢⱼ^{ls′} represents attention scores of the node i and the node j in the time map at the sₜₕ attention head in the layer l, Wₐₜₜ^{ls′} is a learnable weight matrix of the sₜₕ attention head in the layer l, a^{T} is a learnable bias vector, is a splicing operation, and LeakyReLU is a nonlinear activation function.

An output of the variable map attention network is a matrix in a dimension N×ω, and one row of the matrix represents a relation of a node in the variable feature map with its adjacent nodes captured by the map attention network. Similarly, an output of the time map attention network is a matrix in a dimension ω×N. The outputs of the two map attention layers are spliced with original time sequence data to constitute a matrix in a dimension ω×3N and one row of the matrix represents a feature vector in a dimension 3N at a time stamp within the input time window. Finally, the matrix in the dimension ω×3N is used as an input of a gating convolutional network (GRU), and as a variant of a recurrent convolutional network, the GRU can well capture sequence pattern information in the data to obtain target features.

In order to utilize the advantages based on the reconstruction models and based on the prediction models at the same time, a loss function of MTS-GAT contains two goals: capturing distribution of entire input data at the reconstructing module and accurately predicting a value at the next time stamp at the predicting module. Inputs [symbol] ₜ of the reconstructing module and the predicting module at time t are an output of XχXGRU. A loss function for joint optimization is defined by Formula (45):

$$ℒ = {γ}_{1} {ℒ}_{r e c} + ( 1 - {γ}_{1} ) {ℒ}_{p r e d} \qquad ( 45 )$$

[symbol] _{rec} is a loss function of the reconstructing module, [symbol] _{pred} is a loss function of the predicting module, and γ₁ is a hyper-parameter for balancing weights of the two modules.

The predicting module uses [symbol] ₜ to predict an observation value at the next time stamp, in this section, a multilayer perceptron (MLP) is used as the predicting module, and the loss function is defined by Formula (46):

$${ℒ}_{p r e d} = \sqrt{{\sum }_{i = 1}^{N} {( {x}_{i , t + 1} - {\hat{x}}_{i , t + 1} )}^{2}} \qquad ( 46 )$$

In the formula, x_{i,t+1} is a measured value of the iₜₕ time sequence at t+1 and \hat{x}_{i,t+1} is a predicted value of the iₜₕ sequence at the moment t+1.

The reconstructing module is to learn a reconstruction probability of the input data. In order to enhance the robustness of the models, two arbiters D_{E}(·) and D_{D}(·) are used to perform adversarial training on an autoencoder G_{A} to be used as a reconstruction-based model. An encoder G_{E}(·) and a decoder G_{D}(·) of G_{A} may be regarded as two generators. An adversarial generative network model is as shown in FIG. 5, for a given input [symbol] ₜ, z is a potential representation of the autoencoder, p(z) represents priori distribution of z posteriori distribution generated by the autoencoder in a potential space is q(z), and it is calculated through Formula (47):

$$q ( z ) = {\int }_{{𝒳}_{t}} q ( z \vert {𝒳}_{t} ) {p}_{d} ( {𝒳}_{t} ) d {𝒳}_{t} \qquad ( 47 )$$

In the formula, q(z| [symbol] ₜ) represents encoding distribution, and p_{d}( [symbol] ₜ) represents distribution of the input data. An adversarial network D_{E}(·) is used to adjust posteriori distribution q(z) to make it satisfy priori distribution p(z), namely maximizing a loss function [symbol] _{D}_{_{E}}, which is calculated through Formula (48):

$${ℒ}_{{D}_{E}} = {𝔼}_{z \sim p ( z )} [ log ( {D}_{E} ( z ) ) ] + {𝔼}_{{𝒳}_{t} \sim {p}_{d} ( {𝒳}_{t} )} [ log ( 1 - {D}_{E} ( {G}_{E} ( {𝒳}_{t} ) ) ) ] \qquad ( 48 )$$

The corresponding generator G_{E}(·) mixes D_{E}(·), namely minimizing a loss function [symbol] _{G}_{_{E}}, which is calculated through Formula (49):

$${ℒ}_{{G}_{E}} = {𝔼}_{{𝒳}_{t} - {p}_{d} ( {𝒳}_{t} )} [ log ( 1 - {D}_{E} ( {G}_{E} ( {𝒳}_{t} ) ) ) ] \qquad ( 49 )$$

Similarly, the adversarial network D_{D}(·) avoids an over-fitting problem of the models by increasing a difference between the input data and reconstructed data, namely maximizing a loss function [symbol] _{D}_{_{D}}, which is calculated through Formula (50):

$${ℒ}_{{D}_{E}} = {𝔼}_{{𝒳}_{t} \sim {p}_{d} ( {𝒳}_{t} )} [ log ( {D}_{D} ( {𝒳}_{t} ) ) + log ( 1 - {D}_{D} ( {G}_{A} ( {𝒳}_{t} ) ) ) ] \qquad ( 50 )$$

The corresponding generator G_{D}(·) needs to minimize a loss function [symbol] _{G}_{_{D}}, which is calculated through Formula (51):

$${ℒ}_{{G}_{D}} = {𝔼}_{{𝒳}_{t} \sim {p}_{d} ( {𝒳}_{t} )} [ log ( 1 - {D}_{D} ( {G}_{A} ( {𝒳}_{t} ) ) ) ] \qquad ( 51 )$$

The reconstruction of the input data denotes [symbol] ′ₜ=G_{D}(G_{E}( [symbol] ₜ)) Finally, [symbol] _{G}_{_{E}} and [symbol] _{G}_{_{D}} are used as adversarial regularization to guarantee the robustness of the reconstruction model, and a loss function of the reconstruction model is defined by Formula (52) and Formula (53):

$${ℒ}_{r e c} = {ℒ}_{r} + {ℒ}_{{G}_{E}} + {ℒ}_{{G}_{D}} \qquad ( 52 )$$

$${ℒ}_{r} = {𝔼}_{{𝒳}_{t} \sim {p}_{d} ( {𝒳}_{t} )} {‖ {𝒳}_{t} - {G}_{A} ( {𝒳}_{t} ) ‖}_{1} \qquad ( 53 )$$

In the formulas, [symbol] ᵣ denotes a reconstruction loss.

For an iₜₕ univariate time sequence, at any time stamp t, the predicting module generates a predicted value \hat{x}ᵢ, and the reconstructing module generates the reconstruction probability pₜ. A final abnormal score at each time stamp balances weights of the two modules through Formula (54):

$$score = {\sum }_{i = 1}^{N} \frac{( 1 - {p}_{i} ) + {{γ}_{2} ( {x}_{i} - {\hat{x}}_{i} )}^{2}}{1 + {γ}_{2}} \qquad ( 54 )$$

In the formula, xᵢ is a measured value, and γ₂ is a hyper-parameter for balancing the two modules. At an abnormality detection phase, when an abnormal score at a certain time stamp is greater than a given abnormality threshold, the time stamp is marked as an “abnormal time stamp”, otherwise, it is a “normal time stamp”. The abnormality threshold is selected on a validation set through a peaks-over-threshold (POT) algorithm.

Optionally, in S105, the evaluation analysis is performed on the concrete dam to determine a grade of the concrete dam, wherein the grade of the concrete dam includes “normal”, “basically normal”, “slightly abnormal” and “abnormal”. “Abnormal” indicates that the dam is unable to function and operate effectively; and a corresponding decision support suggestion is: it is urgent to take measures such as releasing reservoir water, and carrying out repair and reinforcement to ensure safe operation of the dam. “Slightly abnormal” indicates that the dam is able to function to a limited extent and operate under a low load condition; and a corresponding decision support suggestion is: on-site safety monitoring and tracking analysis and evaluation need to be strengthened, and measures such as repair and reinforcement need to be taken timely to ensure safe operation of the dam. “Basically normal” indicates that the dam is able to function normally within a short period of time and operate under a normal load condition; and a corresponding decision support suggestion is: on-site safety monitoring needs to be strengthened, and an operation state of the dam needs to be continuously monitored. “Normal” indicates that the dam is able to function normally, operate under a normal load condition, and even operate under a verification working condition; and a corresponding decision support suggestion is: carrying out regular safety monitoring according to daily management.

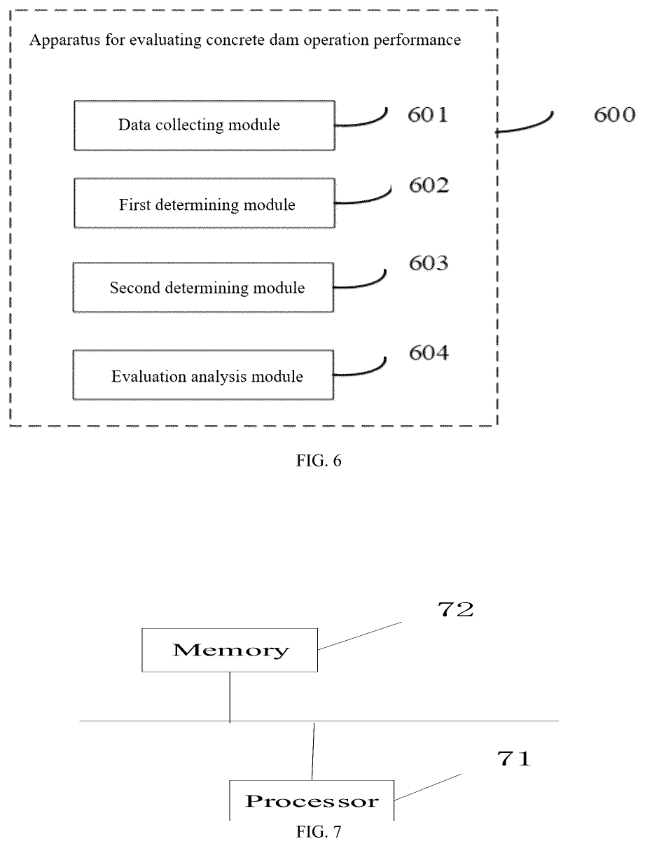

FIG. 6 is a schematic diagram of an on-line evaluation apparatus for concrete dam operation performance shown in the present application. As shown in FIG. 6, the on-line evaluation apparatus for the concrete dam operation performance 600 includes a data collecting module 601, a first determining module 602, a second determining module 603 and an evaluation analysis module 604.

The data collecting module 601 is configured to arrange a monitoring system on a concrete dam, so as to collect same-type multi-measuring-point monitoring data and multi-type multi-measuring-point monitoring data of the concrete dam, wherein the same-type multi-measuring-point monitoring data include deformation monitoring data, seepage monitoring data, stress-strain monitoring data and temperature monitoring data.

The first determining module 602 is configured to determine various indicator analysis results of the concrete dam based on the same-type multi-measuring-point monitoring data, wherein the various indicator analysis results include a deformation analysis result, a seepage analysis result, a stress-strain analysis result and a temperature analysis result.

The second determining module 603 is configured to determine various indicator operation scoring results of the concrete dam based on the multi-type multi-measuring-point monitoring data, wherein the various indicator operation scoring results include a deformation scoring result, a seepage scoring result and a stress-strain scoring result.

The evaluation analysis module 604 is configured to perform overall evaluation analysis on the concrete dam based on the various indicator analysis results and the various indicator operation scoring results.

In order to implement the above embodiments, an embodiment of the present application further proposes a system for determining evaluation indicators based on an on-line evaluation layered architecture for evaluating concrete dam operation performance. As shown in FIG. 7, an electronic device includes: a processor 71 and a memory 72 in communication connection with the processor 71. The memory 72 has instructions stored therein that can be executed by at least one processor, and the instructions, when executed by the at least one processor 71, causes the at least one processor to implement the method for determining evaluation indicators based on an on-line evaluation layered architecture for evaluating concrete dam operation performance shown in the above embodiment.

In order to implement the above embodiments, an embodiment of the present application further proposes a non-transitory computer-readable storage medium storing computer instructions, wherein the computer instructions are used to enable a computer to implement the method for determining the evaluation indicators based on the on-line evaluation layered architecture for evaluating concrete dam operation performance shown in the above embodiment.

In order to implement the above embodiments, an embodiment of the present application further proposes a computer program product including computer programs, and the computer programs, when executed by a processor, implement the method for determining the evaluation indicators based on the on-line evaluation layered architecture for evaluating concrete dam operation performance shown in the above embodiment.

In the description of the present application, it should be understood that the orientation or positional relationships indicated by the terms “central”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “anticlockwise”, “axial”, “radial”, “circumferential”, etc. are based on the orientation or positional relationships shown in the drawings and are only for facilitating the description of the present application and simplifying the description, rather than indicating or implying that the apparatus or element referred to must have a particular orientation or be constructed and operated in a particular orientation, and therefore will not be interpreted as limiting the present application.

In addition, the terms “first” and “second” are only for descriptive purposes and cannot be understood as indicating or implying relative importance or implicitly specifying the quantity of technical features indicated. Therefore, features that are defined by “first” and “second” may explicitly or implicitly include one or more of the features. In the description of the present application, the meaning of “a plurality of” is two or more, unless otherwise explicitly and specifically defined.

In the description of the specification, descriptions with reference to the terms “one embodiment”, “some embodiments”, “examples”, “specific examples”, or “some examples” means that specific features, structures, materials, or characteristics described in conjunction with the embodiments or examples are included in at least one embodiment or example of the present application. In the specification, the schematic expressions of the above terms do not necessarily refer to the same embodiments or examples. Moreover, the specific features, structures, materials, or characteristics described may be combined in any one or more embodiments or examples in an appropriate manner. In addition, those skilled in the art may combine the different embodiments or examples described in the specification, as well as the features of the different embodiments or examples, without conflicting with each other.

Although the embodiments of the present application have been shown and described above, it can be understood that, the above embodiments are exemplary and should not be construed as limiting the present application. Those of ordinary skills in the art may make changes, modifications, substitutions, and variations to the above embodiments within the scope of the present application.

1. A method for determining evaluation indicators based on an on-line evaluation layered architecture for evaluating concrete dam operation performance, comprising:
acquiring an on-line evaluation layered model for evaluating concrete dam operation performance, wherein the on-line evaluation layered model comprises an overall project layer, a key part layer, a monitored item layer, an evaluation indicator layer, a diagnosis method layer and a monitoring data layer; wherein
the overall project layer is a target of on-line evaluation of the concrete dam operation performance, and is used to comprehensively assess overall concrete dam operation performance;
the key part layer is a focused object of on-line evaluation of the concrete dam operation performance, and key parts are determined according to computational analysis in a concrete dam design phase or clustering analysis for long-term operation monitoring data, wherein the key part layer is used to analyze assessment results of special items of deformation, seepage, stress-strain and temperature monitoring effect values derived by the monitored item layer, and the key parts are distributed in an upper dam body, a middle dam body, a riverbed dam segment heel, a riverbed dam segment toe and a dam foundation of a concrete dam as well as distribution part regions of defects of long-term concern in project operation;
the monitored item layer is an association medium of on-line evaluation of the concrete dam operation performance, and according to currently-effective standards related to concrete dam design and safety monitoring, the special items of deformation, seepage, stress-strain and temperature monitoring effect values are comprehensively analyzed;
the evaluation indicator layer is a process center of on-line evaluation of the concrete dam operation performance, and four types of evaluation indicators of deformation, seepage, stress-strain and temperature are respectively set corresponding to the deformation, seepage, stress-strain and temperature monitoring effect values of concrete dam operation safety in the monitored item layer, wherein under the various types of evaluation indicators, two indicator determining methods are further included: one is determining same-type multi-measuring-point combined calculation evaluation indicators for structural characteristics, and the other is determining data-driven multi-type multi-measuring-point zoned comprehensive evaluation indicators;
the diagnosis method layer is an analysis core of on-line evaluation of the concrete dam operation performance, and on the basis of periodic effects of reservoir water and temperature loads in an operation period of the concrete dam and structural and material changes inside the concrete dam, same-type multi-point or multi-type multi-point monitoring effect value analysis is performed according to the same-type multi-measuring-point combined calculation evaluation indicators and the multi-type multi-measuring-point zoned comprehensive evaluation indicators; and
the monitoring data layer is an information base of on-line evaluation of the concrete dam operation performance, and comprises engineering safety monitoring data, walkaround inspection defect data and geophysical prospecting detection result data;
performing overall evaluation analysis on the concrete dam based on the on-line evaluation layered model, which comprises the following steps:
collecting same-type multi-measuring-point monitoring data and multi-type multi-measuring-point monitoring data of the concrete dam, wherein the same-type multi-measuring-point monitoring data comprise deformation monitoring data, seepage monitoring data, stress-strain monitoring data and temperature monitoring data;
determining various indicator analysis results of the concrete dam based on the same-type multi-measuring-point monitoring data, wherein the various indicator analysis results comprise a deformation analysis result, a seepage analysis result, a stress-strain analysis result and a temperature analysis result;
determining various indicator operation scoring results of the concrete dam based on the multi-type multi-measuring-point monitoring data, wherein the various indicator operation scoring results comprise a deformation scoring result, a seepage scoring result and a stress-strain scoring result; and
performing evaluation analysis on the concrete dam based on the various indicator analysis results and the various indicator operation scoring results; wherein
the step of determining the various indicator operation scoring results of the concrete dam based on the multi-type multi-measuring-point monitoring data comprises:
performing region division on the key parts in concrete dam operation, and acquiring time-sequence measured value data of different types of monitoring instruments in a certain region from the multi-type multi-measuring-point monitoring data;
establishing map structures for the time-sequence measured value data in time dimension and variable dimension respectively to obtain a time feature map and a variable feature map;
inputting the time feature map and the variable feature map into a time map attention network and a variable map attention network respectively to obtain a time attention matrix and a variable attention matrix;
splicing and inputting the time-sequence measured value data, the time attention matrix and the variable attention matrix into a gating convolutional network to obtain target features; and
calculating abnormal scores according to the target features, and comparing the abnormal scores with preset indicator thresholds to obtain the operation scoring results of the corresponding indicators of the concrete dam; and
wherein the step of calculating the abnormal scores according to the target features comprises:
inputting the target features into a predicting module and a reconstructing module to obtain a prediction value and a reconstruction probability; and
calculating the abnormal scores according to the prediction value and the reconstruction probability.

2. The method according to claim 1, wherein: the evaluation analysis is performed on the concrete dam to determine a grade of the concrete dam, wherein the grade of the concrete dam comprises “normal”, “basically normal”, “slightly abnormal” and “abnormal”;
“abnormal” indicates that the dam is unable to function and operate effectively; and a corresponding decision support suggestion is: it is urgent to take measures such as releasing reservoir water, and carrying out repair and reinforcement to ensure safe operation of the dam;
“slightly abnormal” indicates that the dam is able to function to a limited extent and operate under a low load condition; and a corresponding decision support suggestion is: on-site safety monitoring and tracking analysis and evaluation need to be strengthened, and measures such as repair and reinforcement need to be taken timely to ensure safe operation of the dam;
“basically normal” indicates that the dam is able to function normally within a short period of time and operate under a normal load condition; and a corresponding decision support suggestion is: on-site safety monitoring needs to be strengthened, and an operation state of the dam needs to be continuously monitored; and
“normal” indicates that the dam is able to function normally, operate under a normal load condition, and even operate under a verification working condition; and a corresponding decision support suggestion is: carrying out regular safety monitoring according to daily management.

3. The method according to claim 1, wherein determining the deformation analysis result in the various indicator analysis results of the concrete dam based on the same-type multi-measuring-point monitoring data comprises:
determining deformation analysis parameters of the concrete dam based on the deformation monitoring data in the same-type multi-measuring-point monitoring data, wherein the deformation analysis parameters comprise dam foundation deformation vertical distribution, overall horizontal displacement of a dam body, a horizontal displacement coordination degree of the dam body, an overall deflection of a dam segment, overall settlement of the dam body, inter-layer micro deformation of the dam body, an overall opening degree of a foundation surface and an overall opening degree of a structural joint; and
performing deformation analysis on the concrete dam based on the deformation analysis parameters to obtain the deformation analysis result.

4. The method according to claim 3, wherein determining the seepage analysis result in the various indicator analysis results of the concrete dam based on the same-type multi-measuring-point monitoring data comprises:
determining seepage analysis parameters of the concrete dam based on the seepage monitoring data in the same-type multi-measuring-point monitoring data, wherein the seepage analysis parameters comprise an overall uplift pressure reduction coefficient of the dam foundation, anti-sliding stability of the dam foundation, a structural joint osmotic pressure gradient and a key area seepage change amplitude; and
performing seepage analysis on the concrete dam based on the seepage analysis parameters to obtain the seepage analysis result.

5. The method according to claim 4, wherein determining the stress-strain analysis result in the various indicator analysis results of the concrete dam based on the same-type multi-measuring-point monitoring data comprises:
determining stress-strain analysis parameters of the concrete dam based on the stress-strain monitoring data in the same-type multi-measuring-point monitoring data, wherein the stress-strain analysis parameters comprise dam foundation stress vertical distribution, an overall horizontal stress of the dam body, a vertical beam-direction overall stress and a special part strain measuring point strain change amplitude; and
performing stress-strain analysis on the concrete dam based on the stress-strain analysis parameters to obtain the stress-strain analysis result.

6. The method according to claim 5, wherein determining the temperature analysis result in the various indicator analysis results of the concrete dam based on the same-type multi-measuring-point monitoring data comprises:
determining temperature analysis parameters of the concrete dam based on the temperature monitoring data in the same-type multi-measuring-point monitoring data, wherein the temperature analysis parameters comprise dam foundation temperature distribution and a dam body temperature gradient; and
performing temperature analysis on the concrete dam based on the temperature analysis parameters to obtain the temperature analysis result.

7. The method according to claim 1, wherein the predicting module is a multilayer perceptron.

8. A system for determining evaluation indicators based on an on-line evaluation layered architecture for evaluating concrete dam operation performance, comprising: at least one processor; and a memory in communication connection with the at least one processor; wherein the memory has instructions stored therein that can be executed by the at least one processor, and the instructions, when executed by the at least one processor, causes the at least one processor to implement the method for determining evaluation indicators based on an on-line evaluation layered architecture for evaluating concrete dam operation performance according to claim 1.

9. The system according to claim 8, wherein: the evaluation analysis is performed on the concrete dam to determine a grade of the concrete dam, wherein the grade of the concrete dam comprises “normal”, “basically normal”, “slightly abnormal” and “abnormal”;
“abnormal” indicates that the dam is unable to function and operate effectively; and a corresponding decision support suggestion is: it is urgent to take measures such as releasing reservoir water, and carrying out repair and reinforcement to ensure safe operation of the dam;
“slightly abnormal” indicates that the dam is able to function to a limited extent and operate under a low load condition; and a corresponding decision support suggestion is: on-site safety monitoring and tracking analysis and evaluation need to be strengthened, and measures such as repair and reinforcement need to be taken timely to ensure safe operation of the dam;
“basically normal” indicates that the dam is able to function normally within a short period of time and operate under a normal load condition; and a corresponding decision support suggestion is: on-site safety monitoring needs to be strengthened, and an operation state of the dam needs to be continuously monitored; and
“normal” indicates that the dam is able to function normally, operate under a normal load condition, and even operate under a verification working condition; and a corresponding decision support suggestion is: carrying out regular safety monitoring according to daily management.

10. The system according to claim 8, wherein determining the deformation analysis result in the various indicator analysis results of the concrete dam based on the same-type multi-measuring-point monitoring data comprises:
determining deformation analysis parameters of the concrete dam based on the deformation monitoring data in the same-type multi-measuring-point monitoring data, wherein the deformation analysis parameters comprise dam foundation deformation vertical distribution, overall horizontal displacement of a dam body, a horizontal displacement coordination degree of the dam body, an overall deflection of a dam segment, overall settlement of the dam body, inter-layer micro deformation of the dam body, an overall opening degree of a foundation surface and an overall opening degree of a structural joint; and
performing deformation analysis on the concrete dam based on the deformation analysis parameters to obtain the deformation analysis result.

11. The system according to claim 10, wherein determining the seepage analysis result in the various indicator analysis results of the concrete dam based on the same-type multi-measuring-point monitoring data comprises:
determining seepage analysis parameters of the concrete dam based on the seepage monitoring data in the same-type multi-measuring-point monitoring data, wherein the seepage analysis parameters comprise an overall uplift pressure reduction coefficient of the dam foundation, anti-sliding stability of the dam foundation, a structural joint osmotic pressure gradient and a key area seepage change amplitude; and
performing seepage analysis on the concrete dam based on the seepage analysis parameters to obtain the seepage analysis result.

12. The system according to claim 11, wherein determining the stress-strain analysis result in the various indicator analysis results of the concrete dam based on the same-type multi-measuring-point monitoring data comprises:
determining stress-strain analysis parameters of the concrete dam based on the stress-strain monitoring data in the same-type multi-measuring-point monitoring data, wherein the stress-strain analysis parameters comprise dam foundation stress vertical distribution, an overall horizontal stress of the dam body, a vertical beam-direction overall stress and a special part strain measuring point strain change amplitude; and
performing stress-strain analysis on the concrete dam based on the stress-strain analysis parameters to obtain the stress-strain analysis result.

13. The system according to claim 12, wherein determining the temperature analysis result in the various indicator analysis results of the concrete dam based on the same-type multi-measuring-point monitoring data comprises:
determining temperature analysis parameters of the concrete dam based on the temperature monitoring data in the same-type multi-measuring-point monitoring data, wherein the temperature analysis parameters comprise dam foundation temperature distribution and a dam body temperature gradient; and
performing temperature analysis on the concrete dam based on the temperature analysis parameters to obtain the temperature analysis result.

14. The system according to claim 8, wherein the predicting module is a multilayer perceptron.
